(19) United States
(12) Patent Application Publication
(10) Pub. No.: US 2025/0317263 A1
(43) Pub. Date: Oct. 9, 2025

(54) BANDWIDTH PART (BWP) OPERATION IN SUBBAND FULL DUPLEX (SBFD)

(71) Applicant: QUALCOMM Incorporated, San Diego, CA (US)

(72) Inventors: Prashant SHARMA, San Marcos, CA (US); Jae Ho RYU, San Diego, CA (US); Muhammad Sayed Khairy ABDELGHAFFAR, San Jose, CA (US)

(21) Appl. No.: 19/061,886

(22) Filed: Feb. 24, 2025

Related U.S. Application Data
(60) Provisional application No. 63/575,543, filed on Apr. 5, 2024.
(60) Provisional application No. 63/575,559, filed on Apr. 5, 2024.

(51) Int. Cl. H04L 5/14; H04W 72/044; H04W 72/0453; H04W 74/00

(52) U.S. Cl. CPC H04L 5/14; H04W 72/044; H04W 72/0453; H04W 74/006

(57) ABSTRACT

Aspects of the disclosure are directed to method and techniques for wireless communications between wireless nodes via subband full-duplex (SBFD) resources and non-SBFD resources. In some examples, the wireless nodes may communicate using coupled bandwidth parts (BWPs) of varying bandwidth to accommodate downlink and uplink communications during SBFD resources.

### CROSS REFERENCE TO RELATED APPLICATIONS

The present application for patent claims the benefit of U.S. Provisional Application No. 63/575,543, entitled “BANDWIDTH PART (BWP) OPERATION WITH SUBBAND FULL-DUPLEX (SBFD),” filed Apr. 5, 2024, and U.S. Provisional Application No. 63/575,559, entitled “BANDWIDTH PART (BWP) DECOUPLING,” filed Apr. 5, 2024, each of which is assigned to the assignee hereof and expressly incorporated herein by reference in its entirety.

### BACKGROUND

### Technical Field

The present disclosure generally relates to communication systems, and more particularly, to communications between wireless nodes via bandwidth parts (BWPs) and subband full-duplex (SBFD) resources.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

Aspects are directed to an apparatus for wireless communication. In some examples, the apparatus includes one or more memories, individually or in combination, having instructions, and one or more processors, individually or in combination, configured to execute the instructions. In some examples, the one or more processors are configured to communicate with a wireless node, said communication being via non-subband full-duplex (non-SBFD) resources associated with a channel bandwidth and via a first bandwidth part (BWP) pair. In some examples, the one or more processors are configured to communicate with the wireless node by switching from the first BWP pair to a second BWP pair, said communication being via SBFD resources associated with the channel bandwidth, wherein the second BWP pair occupies a greater portion of the channel bandwidth relative to the first BWP pair.

Aspects are directed to an apparatus for wireless communication. In some examples, the apparatus includes one or more memories, individually or in combination, having instructions, and one or more processors, individually or in combination, configured to execute the instructions. In some examples, the one or more processors are configured to communicate with a wireless node, said communication being via non-subband full-duplex (non-SBFD) resources associated with a channel bandwidth and via a first bandwidth part (BWP) pair. In some examples, the one or more processors are configured to communicate with the wireless node by switching from the first BWP pair to a second BWP pair, said communication being via SBFD resources associated with the channel bandwidth, wherein the second BWP pair comprises a second uplink BWP and a second downlink BWP, and wherein the second uplink BWP is decoupled from the second downlink BWP.

Aspects are directed to a method for wireless communication at a first wireless node. In some examples, the method includes communicating with a second wireless node, said communication being via non-subband full-duplex (non-SBFD) resources associated with a channel bandwidth and via a first bandwidth part (BWP) pair. In some examples, the method includes communicating with the second wireless node by switching from the first BWP pair to a second BWP pair, said communication being via SBFD resources associated with the channel bandwidth, wherein the second BWP pair occupies a greater portion of the channel bandwidth relative to the first BWP pair.

Aspects are directed to a method for wireless communication at an apparatus. In some examples, the method includes communicating with a wireless node, said communication being via non-subband full-duplex (non-SBFD) resources associated with a channel bandwidth and via a first bandwidth part (BWP) pair. In some examples, the method includes communicating with the wireless node by switching from the first BWP pair to a second BWP pair, said communication being via SBFD resources associated with the channel bandwidth, wherein the second BWP pair comprises a second uplink BWP and a second downlink BWP, and wherein the second uplink BWP is decoupled from the second downlink BWP.

Aspects are directed to an apparatus for wireless communication. In some examples, the apparatus includes means for communicating with a wireless node, said communication being via non-subband full-duplex (non-SBFD) resources associated with a channel bandwidth and via a first bandwidth part (BWP) pair. In some examples, the apparatus includes means for communicating with the wireless node by switching from the first BWP pair to a second BWP pair, said communication being via SBFD resources associated with the channel bandwidth, wherein the second BWP pair occupies a greater portion of the channel bandwidth relative to the first BWP pair.

Aspects are directed to an apparatus for wireless communication. In some examples, the apparatus includes means for communicating with a wireless node, said communication being via non-subband full-duplex (non-SBFD) resources associated with a channel bandwidth and via a first bandwidth part (BWP) pair. In some examples, the apparatus includes means for communicating with the wireless node by switching from the first BWP pair to a second BWP pair, said communication being via SBFD resources associated with the channel bandwidth, wherein the second BWP pair comprises a second uplink BWP and a second downlink BWP, and wherein the second uplink BWP is decoupled from the second downlink BWP.

Aspects are directed to a non-transitory computer-readable medium comprising instructions that, when executed by a first wireless node, cause the first wireless node to perform a method. In some examples, the method includes communicating with a second wireless node, said communication being via non-subband full-duplex (non-SBFD) resources associated with a channel bandwidth and via a first bandwidth part (BWP) pair. In some examples, the method includes communicating with the second wireless node by switching from the first BWP pair to a second BWP pair, said communication being via SBFD resources associated with the channel bandwidth, wherein the second BWP pair occupies a greater portion of the channel bandwidth relative to the first BWP pair.

Aspects are directed to a non-transitory computer-readable medium comprising instructions that, when executed by a wireless node, cause the wireless node to perform a method. In some examples, the method includes communicating with another wireless node, said communication being via non-subband full-duplex (non-SBFD) resources associated with a channel bandwidth and via a first bandwidth part (BWP) pair. In some examples, the method includes communicating with the other wireless node by switching from the first BWP pair to a second BWP pair, said communication being via SBFD resources associated with the channel bandwidth, wherein the second BWP pair comprises a second uplink BWP and a second downlink BWP, and wherein the second uplink BWP is decoupled from the second downlink BWP.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a block diagram illustrating an example disaggregated base station architecture.

FIG. 5 is a block diagram illustrating an example of half-duplex communications in which a network entity configures a downlink bandwidth part (BWP) and an uplink BWP.

FIG. 6 is a block diagram conceptually illustrating an example of sub-band full-duplex (SBFD) time-frequency resources in a time-domain division (TDD) configuration.

FIG. 7 is a block diagram illustrating an example of usable physical resource blocks (PRB) of a BWP located within SBFD symbols.

FIG. 8 is a block diagram illustrating another example of usable PRBs of a BWP located within SBFD symbols.

FIG. 9 is a block diagram illustrating an example of usable PRBs of a decoupled BWP pair located within SBFD symbols.

FIG. 10 is a block diagram illustrating an example of usable PRBs of a coupled BWP pair located within SBFD symbols.

FIG. 11 is a block diagram illustrating another example of usable PRBs of a coupled BWP pair located within SBFD symbols.

FIG. 12 is a block diagram illustrating an example TDD pattern within which a UE and network entity may modify or change BWPs based on whether a corresponding TDD slot is a downlink, uplink, or SBFD slot.

FIG. 13 is a block diagram illustrating an example of BWP expansion between SBFD slot and a non-SBFD slot(s).

FIG. 14 is a call-flow diagram illustrating example communications between a UE and a network entity.

FIG. 15 is a flowchart of a method of wireless communication.

FIG. 16 is a diagram illustrating an example of a hardware implementation for an example apparatus.

FIG. 17 is another flowchart of a method of wireless communication.

FIG. 18 is a diagram illustrating another example of a hardware implementation for another example apparatus.

FIG. 19 is a flowchart of a method of wireless communication.

FIG. 20 is a flowchart of a method of wireless communication.

FIG. 21 is a flowchart of a method of wireless communication.

FIG. 22 is a diagram illustrating an example of a hardware implementation for an example apparatus.

FIG. 23 is a flowchart of a method of wireless communication.

FIG. 24 is a flowchart of a method of wireless communication.

FIG. 25 is a flowchart of a method of wireless communication.

FIG. 26 is a diagram illustrating another example of a hardware implementation for another example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

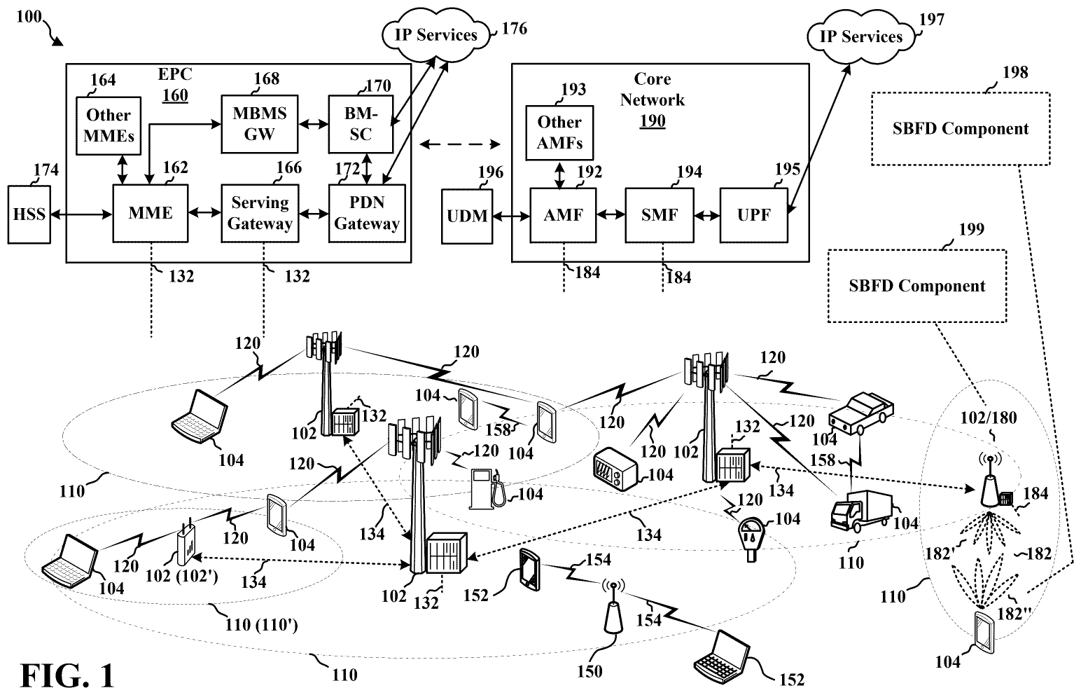

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A wireless node may comprise a UE, a base station, or a network entity.

Referring again to FIG. 1, the UE 104 may include an SBFD component 198. As described in more detail elsewhere herein, the SBFD component 198 may be configured to communicate with a wireless node, said communication being via non-subband full-duplex (non-SBFD) resources associated with a channel bandwidth and via a first bandwidth part (BWP) pair; and communicate with the wireless node by switching from the first BWP pair to a second BWP pair, said communication being via SBFD resources associated with the channel bandwidth, wherein the second BWP pair comprises a second uplink BWP and a second downlink BWP, and wherein the second uplink BWP is decoupled from the second downlink BWP. In certain aspects, the SBFD component 198 may be configured to communicate with a wireless node, said communication being via non-subband full-duplex (non-SBFD) resources associated with a channel bandwidth and via a first bandwidth part (BWP) pair; and communicate with the wireless node by switching from the first BWP pair to a second BWP pair, said communication being via SBFD resources associated with the channel bandwidth, wherein the second BWP pair comprises a second uplink BWP and a second downlink BWP, and wherein the second uplink BWP is decoupled from the second downlink BWP. Additionally, or alternatively, the SBFD component 198 may perform one or more other operations described herein.

The base station 102/180 may include an SBFD component 199. As described in more detail elsewhere herein, the SBFD component 199 may be configured to communicate with a wireless node, said communication being via non-subband full-duplex (non-SBFD) resources associated with a channel bandwidth and via a first bandwidth part (BWP) pair; and communicate with the wireless node by switching from the first BWP pair to a second BWP pair, said communication being via SBFD resources associated with the channel bandwidth, wherein the second BWP pair comprises a second uplink BWP and a second downlink BWP, and wherein the second uplink BWP is decoupled from the second downlink BWP. In certain aspects, the SBFD component 199 may be configured to communicate with a wireless node, said communication being via non-subband full-duplex (non-SBFD) resources associated with a channel bandwidth and via a first bandwidth part (BWP) pair; and communicate with the wireless node by switching from the first BWP pair to a second BWP pair, said communication being via SBFD resources associated with the channel bandwidth, wherein the second BWP pair comprises a second uplink BWP and a second downlink BWP, and wherein the second uplink BWP is decoupled from the second downlink BWP Additionally, or alternatively, the SBFD component 199 may perform one or more other operations described herein.

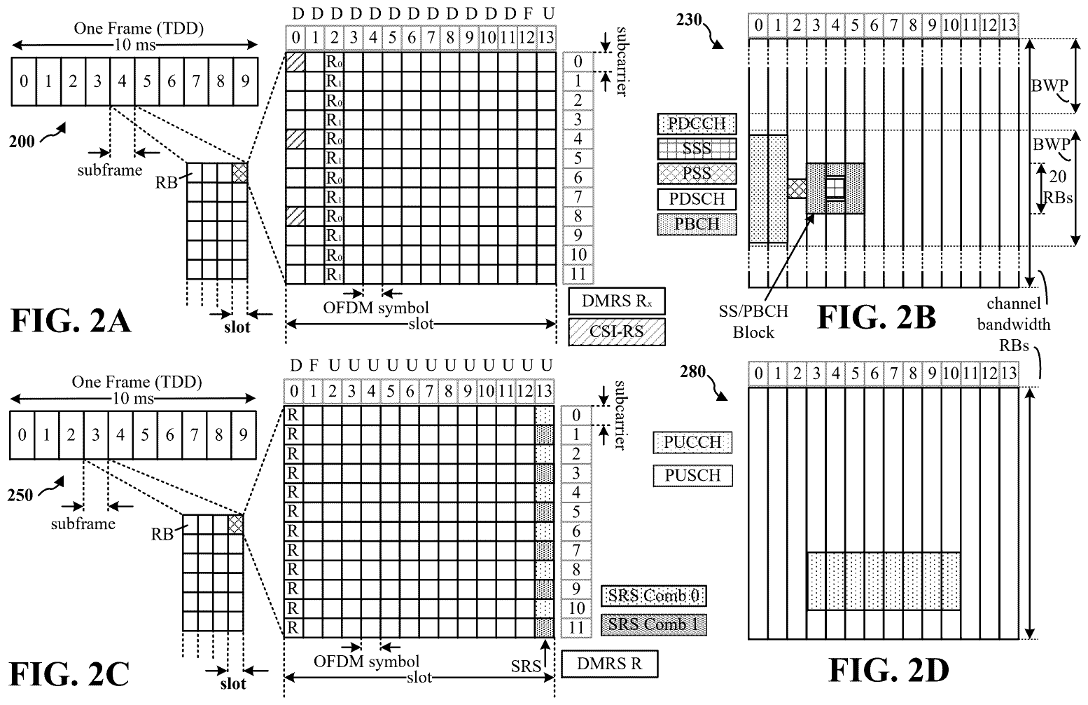

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kilohertz (kHz), where y is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 s. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

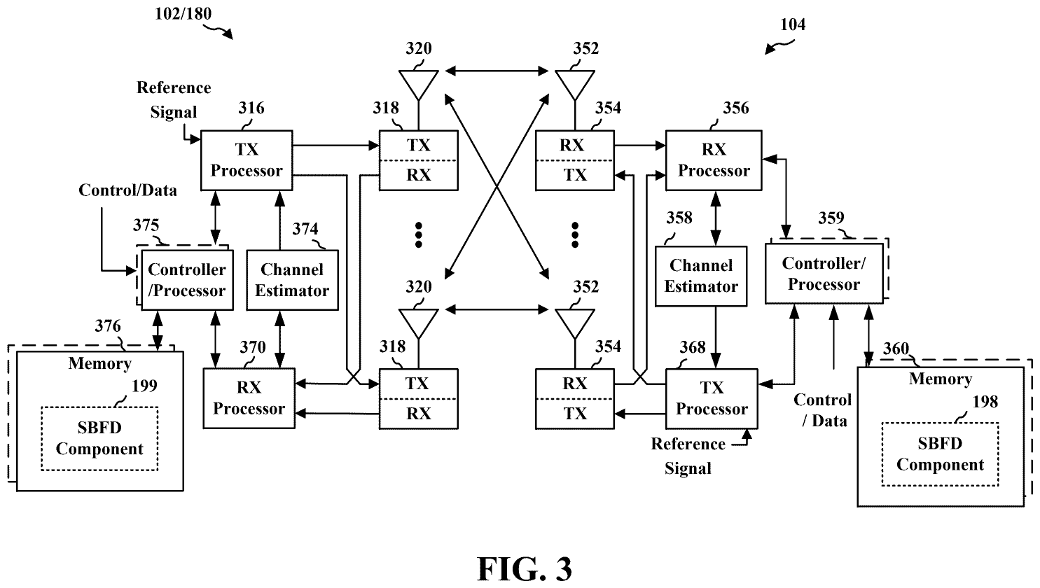

FIG. 3 is a block diagram of a base station 102/180 in communication with a UE 104 in an access network. In the DL, IP packets from the EPC 160 may be provided to one or more controller/processors 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 104. Each spatial stream may then be provided to a different antenna 320 via a separate transmitter 318TX. Each transmitter 318TX may modulate an RF carrier with a respective spatial stream for transmission.

At the UE 104, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 104. If multiple spatial streams are destined for the UE 104, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 102/180. These soft decisions may be based on channel estimates computed by the channel estimator 358. The soft decisions are then decoded and deinterleaved to recover the data and control signals that were originally transmitted by the base station 102/180 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 102/180, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 102/180 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 102/180 in a manner similar to that described in connection with the receiver function at the UE 104. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). In the UL, the controller/processor 375 provides demultiplexing between transport and logical channels, packet reassembly, deciphering, header decompression, control signal processing to recover IP packets from the UE 104. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 199 of FIG. 1.

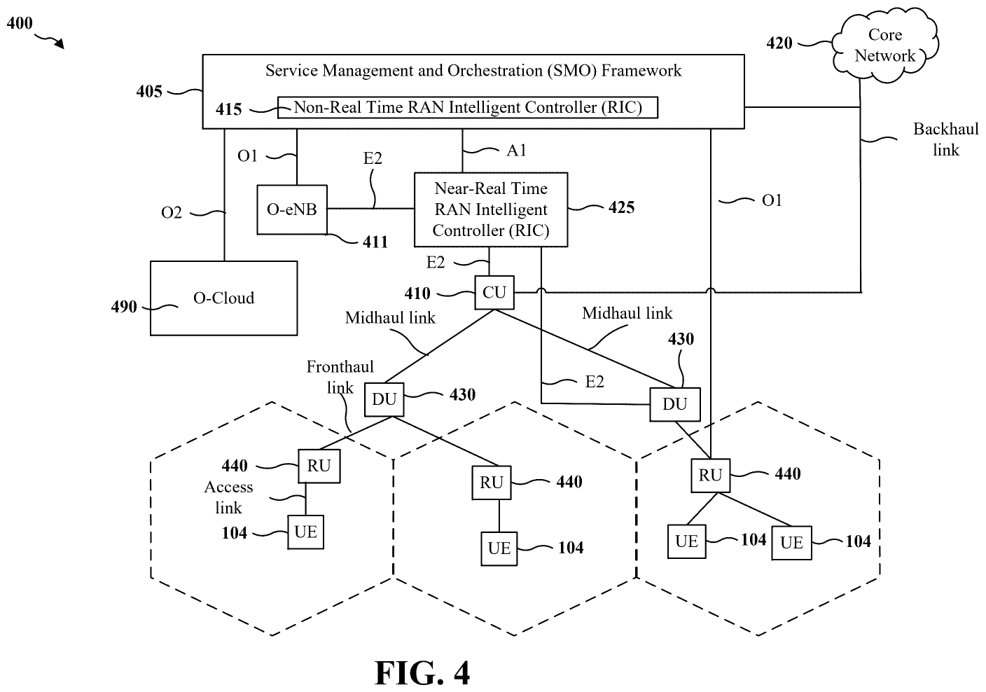

FIG. 4 is a block diagram illustrating an example disaggregated base station 400 architecture. The disaggregated base station 400 architecture may include one or more CUs 410 that can communicate directly with a core network 420 via a backhaul link, or indirectly with the core network 420 through one or more disaggregated base station units (such as a near real-time (RT) RIC 425 via an E2 link, or a non-RT RIC 415 associated with a service management and orchestration (SMO) Framework 405, or both). A CU 410 may communicate with one or more DUs 430 via respective midhaul links, such as an F1 interface. The DUs 430 may communicate with one or more RUs 440 via respective fronthaul links. The RUs 440 may communicate with respective UEs 104 via one or more radio frequency (RF) access links. In some implementations, the UE 104 may be simultaneously served by multiple RUs 440. As used herein, a network entity may correspond to a base station or to a disaggregated aspect (e.g., CU/DU/RU, etc.) of the base station.

Each of the units, i.e., the CUs 410, the DUs 430, the RUs 440, as well as the near-RT RICs 425, the non-RT RICs 415 and the SMO framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., central unit-user plane (CU-UP)), control plane functionality (i.e., central unit-control plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a virtual RAN (vRAN) architecture.

The SMO Framework 405 may be configured to support RAN deployment and provisioning of non-virtualized and virtualized network elements. For non-virtualized network elements, the SMO framework 405 may be configured to support the deployment of dedicated physical resources for RAN coverage requirements, which may be managed via an operations and maintenance interface (such as an O1 interface). For virtualized network elements, the SMO framework 405 may be configured to interact with a cloud computing platform (such as an open cloud (O-cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and near-RT RICs 425. In some implementations, the SMO framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO framework 405 also may include the non-RT RIC 415 configured to support functionality of the SMO Framework 405.

The non-RT RIC 415 may be configured to include a logical function that enables non-real-time control and optimization of RAN elements and resources, artificial intelligence/machine learning (AI/ML) workflows including model training and updates, or policy-based guidance of applications/features in the near-RT RIC 425. The non-RT RIC 415 may be coupled to or communicate with (such as via an AI interface) the near-RT RIC 425. The near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the near-RT RIC 425.

In some implementations, to generate AI/ML models to be deployed in the near-RT RIC 425, the non-RT RIC 415 may receive parameters or external enrichment information from external servers. Such information may be utilized by the near-RT RIC 425 and may be received at the SMO Framework 405 or the non-RT RIC 415 from non-network data sources or from network functions. In some examples, the non-RT RIC 415 or the near-RT RIC 425 may be configured to tune RAN behavior or performance. For example, the non-RT RIC 415 may monitor long-term trends and patterns for performance and employ AI/ML models to perform corrective actions through the SMO Framework 405 (such as reconfiguration via 01) or via creation of RAN management policies (such as AI policies).

### Examples of a Bandwidth Part (BWP)

Generally, a bandwidth part (BWP) is a contiguous set of physical resource blocks (PRBs) for a given numerology on a given carrier. BWPs facilitate power-efficient communication between a network entity 102 and a UE 104 on the given carrier or band. For instance, a network entity may assign resources specifically within an active BWP for a UE (as opposed to broadly within PRBs of the entire band), and the UE may search for data or signaling from the network entity in the active BWP rather than within PRBs of the entire band.

The network entity 102 may provide a radio resource control (RRC) configuration to a UE 104, such as a RRC reconfiguration, which may configure uplink and downlink BWPs with various parameters. These RRC parameters may include, for example, a BWP identifier (e.g., BWP-Id) or index for each BWP, a location and number of contiguous PRBs in frequency for each BWP, a subcarrier spacing for each BWP, and/or a cyclic prefix for each BWP. Moreover, the RRC configuration may indicate an initial downlink BWP for initial downlink transmissions (e.g., a control resource set (CORESET) #0), an initial uplink BWP for initial uplink transmissions (e.g., following reconfiguration or activation of a cell), a BWP inactivity timer (e.g., a timer which may increment by 0.5 or 1 ms depending on frequency range each period that a DCI is not received), a default downlink BWP (e.g., a downlink BWP to which the network entity and UE may switch in response to expiration of the BWP inactivity timer), a first active downlink BWP for downlink transmissions (e.g., following reconfiguration or activation of a cell), and a first active uplink BWP for uplink transmission (e.g., following reconfiguration or activation of a cell). Generally, a network entity may configure up to four downlink BWPs and up to four uplink BWPs for a UE, of which only 1 BWP may be active in a uplink or downlink direction at a given time.

A network entity 102 and UE 104 may switch between different BWPs for wireless communications. In some examples, switching BWPs may involve activating a configured (de-activated) BWP and de-activating an active BWP. In one approach, the network entity may provide a DCI and/or MAC-CE including a bandwidth part indicator field indicating a BWP index, and the UE may switch to an active BWP corresponding to the indicated BWP index in response to the DCI or MAC-CE. The DCI may be configured for a downlink assignment or an uplink grant. For instance, the network entity may configure the DCI to indicate a BWP index corresponding to a configured uplink BWP or downlink BWP, and if the indicated BWP index is different than that of a current active BWP, the UE may switch to the corresponding uplink or downlink BWP.

In another approach, the network entity 102 and UE 104 may switch to an active BWP, namely, a configured default downlink BWP, in response to expiration of a configured BWP inactivity timer. For instance, if an RRC configuration indicates a configured downlink BWP as the default downlink BWP, and if a DCI indicating a downlink assignment or uplink grant is not received at the UE within the time indicated by the BWP inactivity timer, the network entity and UE may switch to the default downlink BWP. In a further approach, the network entity and UE may switch to an active BWP in response to RRC signaling. For instance, if an RRC configuration indicates a configured downlink BWP as a first active downlink BWP or a configured uplink BWP as a first active uplink BWP, then upon reconfiguration or activation of a serving cell, the network entity and UE may switch to the indicated first active downlink BWP or the indicated first active uplink BWP. In an additional approach, the medium access control (MAC) element of the UE may itself switch to an active BWP upon initiation of a random-access procedure.

In TDD deployments, the network entity 102 may provide a slot format configuration to the UE 104 indicating which symbols of a slot are downlink, uplink, or flexible (used for either uplink or downlink communications). The network entity may provide the slot format configuration, for example, in a system information block (e.g., SIB1), an RRC reconfiguration, a DCI, and/or MAC-CE. The slot format configuration may also be a common TDD configuration for a cell, or a dedicated TDD configuration for a UE.

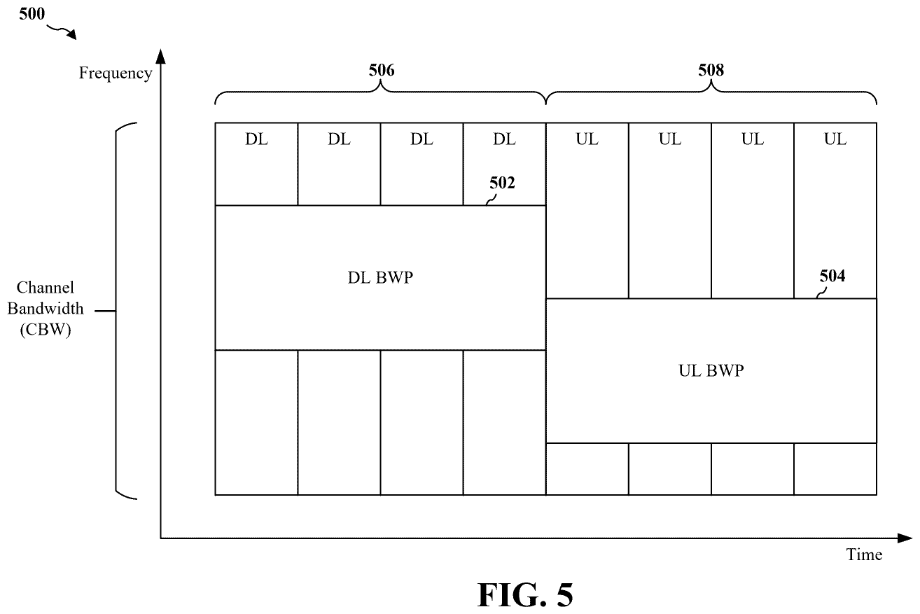

TDD deployments may be a half-duplex communication, wherein a network entity 102 or UE 104 may transmit and receive data at different times, but not at the same time. For instance, FIG. 5 illustrates an example 500 of half-duplexing in which the network entity configures a downlink BWP 502 and an uplink BWP 504 respectively occupying a plurality of downlink symbols 506 and a plurality of uplink symbols 508 within a channel bandwidth (CBW) at different times. Thus, a downlink BWP and uplink BWP may respectively occupy different symbols of a CBW in half-duplex communication. The network entity may configure the UE with the downlink BWP 502 and uplink BWP 504 in an RRC configuration such as previously described, and the network entity may configure the downlink symbols 506 and uplink symbols 508 to occur in TDD according to a slot format configuration for the cell or UE such as previously described.

For TDD operations (e.g., unpaired spectrum operations), it should be noted that the UE 104 may not expect to receive a configuration where the center frequency for a downlink BWP is different than the center frequency for an uplink BWP when the BWP-Id of the downlink BWP is same as the BWP-Id of the uplink BWP. Accordingly, in a TDD band, downlink and uplink BWPs may have the same center frequency even if each of the downlink and uplink BWPs have a different number of PRBs relative to the other.

Recently, interest has turned toward what may be referred to as sub-band full-duplex (SBFD), and how a UE 104 and network entity 102 may communicate using SBFD symbols in a TDD configuration. In some examples, the network entity may configure the UE with a TDD pattern having a certain number of downlink slots or symbols, a certain number of uplink slots or symbols, and a certain number of flexible slots or symbols that may be used as SBFD slots or symbols. An SBFD slot differs from TDD in that in TDD, a given slot is typically fully dedicated to either uplink or downlink communication. With SBFD, a first portion of the time-frequency resources on a given carrier are dedicated for uplink and a second portion of the time-frequency resources on that same carrier support downlink. Accordingly, a network entity communicating utilizing SBFD may transmit downlink and receive uplink at the same time, but on different frequency resources of the same carrier. That is, the downlink resource is separated from the uplink resource in the frequency domain.

### Example of Sub-Band Full-Duplex Communications

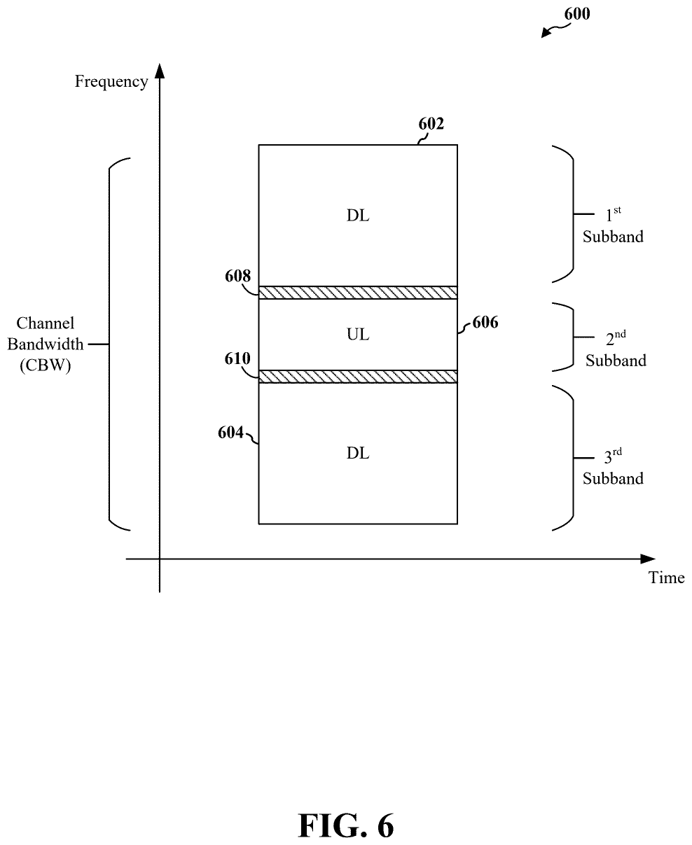

FIG. 6 is a block diagram conceptually illustrating an example of SBFD time-frequency resources in a TDD configuration. Here, an SBFD slot 600 includes an allocated first downlink subband 602, an allocated second downlink subband 604, an allocated uplink subband 606, a first guard band 608 and a second guard band 610. Thus, in an SBFD slot, neither an uplink subband nor a downlink subband may occupy the entire frequency resource range (e.g., the CBW). In the illustrated example, the uplink subband 606 is symmetric about a center frequency. As such, the bandwidth for the second downlink subband 604 and the first downlink subband 602 may be equal. However, in alternative embodiments, the bandwidths of the second downlink subband 604 and the first downlink subband 602 may be different.

Thus, an SBFD slot is a slot in which the frequency band is used for both uplink and downlink transmissions. The uplink and downlink transmissions can occur in adjacent bands (e.g., subbands) as opposed to an IBFD communication with overlapping bands. In a given SBFD slot, a half-duplex UE 104 may either transmit in the uplink band or receive in the downlink band, while a full duplex network entity 102 may transmit in the uplink band and receive in the downlink band of the same slot.

In some examples, a network entity 102 may provide a semi-static indication of time and/or frequency location(s) of SBFD subbands to UEs in an RRC connected mode. For instance, such an indication may be provided via one or more of a system information block (SIB), an RRC configuration message, a DCI, and/or a MAC-CE.

The network entity 102 may also provide the UE 104 with an indication of one or more UE behaviors during SBFD symbols. For example, the UE behaviors may include transmission, reception, measurement, and other suitable behaviors and/or procedures that the UE 104 may perform during SBFD and/or non-SBFD symbols. In some examples, transmission and reception behaviors during SBFD symbols may limit the UE 104 to uplink transmission only (e.g., no downlink reception), or downlink reception only (e.g., no uplink transmission).

In some examples, the network entity 102 may provide the UE 104 with an indication of guard band locations during SBFD symbols. For example, the network entity 102 may indicate time and/or frequency locations of guard bands. Such guard bands may be cell-specific or UE-specific.

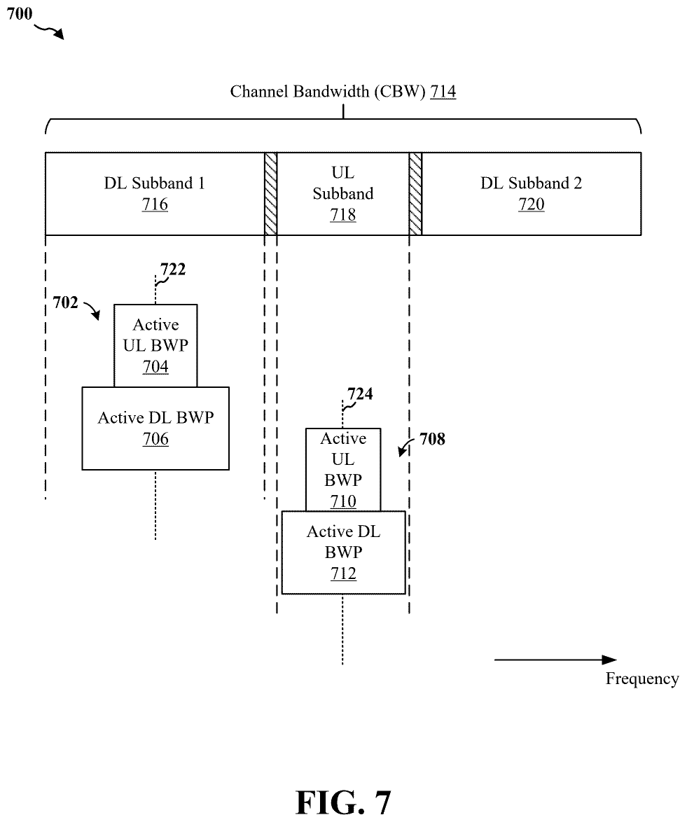

FIG. 7 is a block diagram illustrating an example 700 of usable physical resource blocks (PRB) of a BWP located within SBFD symbols. Here, a channel bandwidth (CBW) 714 used for communication between a UE 104 and a network entity 102 during SBFD symbols is divided into three subbands: a first downlink subband 716, an uplink subband 718, and a second downlink subband 720. As illustrated, an x-axis advances to the right in terms of frequency. The y-axis is unitless because FIG. 7 illustrates an example of usable PRBs for given BWPs; however, the usable PRBs and active BWPs that are illustrated represent a bandwidth division at a given time instance.

A UE 104 may be configured with active BWPs that do not occupy the entire CBW 714. Because the frequency spectrum of the BWPs is smaller than that of the CBW 714, the UE 104 can save power by, for example, monitoring for downlink communications within the smaller BWP frequency spectrum as opposed to the entire SBW. However, UE 104 operations with BWPs having a smaller frequency spectrum may lead to problems during communications within SBFD symbols. As illustrated, the downlink and uplink BWPs may lie completely within either the uplink subband 718 or one of the first downlink subband 716 or second downlink subband 720.

In a first example, a first coupled BWP 702 (e.g., an uplink BWP sharing a common center frequency 722 with a downlink BWP) may include a first active uplink BWP 704 and a first active downlink BWP 706. Here, the first coupled BWP 702 lies completely within the first downlink subband 716. As a result, the UE 104 may receive signaling using all the PRBs of the first active downlink BWP 706 but is unable to transmit uplink communications because the first active uplink BWP 704 falls within the first downlink subband 716. Thus, there are no usable PRBs for uplink transmission.

Similarly, in a second example, a second coupled BWP 708 may include a second active uplink BWP 710 and a second active downlink BWP 712, both horizontally symmetric about a common center frequency 724. Here, the second coupled BWP 708 lies completely within the uplink subband 718. As a result, the UE 104 may transmit uplink communications using all the PRBs of the second active uplink BWP 710 but is unable to receive downlink communications because the second active downlink BWP 712 falls within the uplink subband 718. Thus, there are no usable PRBs for receiving a downlink transmission.

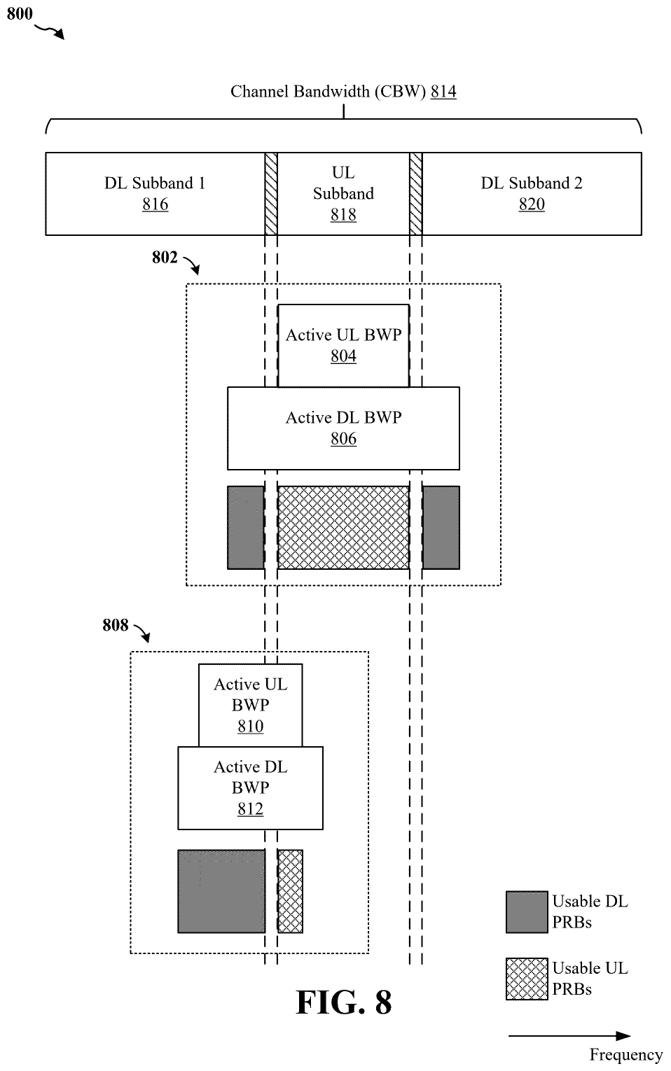

FIG. 8 is a block diagram illustrating another example 800 of usable physical resource blocks (PRB) of a BWP located within SBFD symbols. Here, a channel bandwidth (CBW) 814 used for communication between a UE 104 and a network entity 102 during SBFD symbols is divided into three subbands: a first downlink subband 816, an uplink subband 818, and a second downlink subband 820. As illustrated, an x-axis advances to the right in terms of frequency. The y-axis is unitless because FIG. 8 illustrates an example of usable PRBs for given BWPs; however, the usable PRBs and active BWPs that are illustrated represent a bandwidth division at a given time instance.

As with FIG. 7, UE 104 operations with active BWPs having a frequency spectrum smaller than the CBW 814 may lead to problems during communications within SBFD symbols. As illustrated, the downlink and uplink BWPs may lie completely within either the uplink subband 818 and/or overlapping multiple subbands.

In a first example, a first coupled BWP 802 may include a first active uplink BWP 804 and a first active downlink BWP 806. Here, both the first active uplink BWP 804 and the first active downlink BWP 806 are symmetric about a common center frequency, lie completely within the uplink subband 818, and the first active downlink BWP 806 overlaps with both the first downlink subband 816 and the second downlink subband 820. As a result, the UE 104 may transmit uplink signaling using all the PRBs of the first active uplink BWP 804, but the UE 104 may be unable to receive downlink communications because of the limited usable downlink PRBs.

Similarly, in a second example, a second coupled BWP 808 may include a second active uplink BWP 810 and a second active downlink BWP 812 symmetric about a common center frequency. Here, the second coupled BWP 808 lies between the first downlink subband 816 and the uplink subband 818. As a result, the UE 104 has limited usable PRBs for both the second active uplink BWP 810 and a second active downlink BWP 812. In other words, the UE 104 is limited to less than all PRBs of the second coupled BWP 808 that it can use for either uplink or downlink communications.

The UE 104 may be wasting power in the scenarios illustrated in FIGS. 7 and 8. For example, the UE's RF front end may be powered on and monitoring the second active downlink BWP 712 of FIG. 7 despite the second active downlink BWP 712 having no usable PRBs. Similarly, the UE's RF front end may be powered on and monitoring the first active downlink BWP 806 despite only a limited portion of the BWP having usable PRBs. Accordingly, aspects of the disclosure are directed to methods and techniques for power saving at the UE and improving wireless communications in BWP and SBFD scenarios.

It should be noted that, for FIGS. 7 and 8, usable uplink PRBs are directed to uplink subband (e.g., uplink subband 718/818) frequency resources within an active uplink BWP (e.g., first active uplink BWP 704/804, second active uplink BWP 710/810). Similarly, usable downlink PRBs are directed to downlink subband (e.g., first downlink subband 716/816, second downlink subband 720/820) frequency resources within an active downlink BWP (e.g., first active downlink BWP 706/806, second active downlink BWP 712/812). Moreover, the uplink subband (e.g., uplink subband 718/818) frequency resources and the downlink subband (e.g., first downlink subband 716/816, second downlink subband 720/820) frequency resources may be cell-specific and configured by the network entity 102.

In some examples, the UE 104 and/or network entity 102 may determine the usable uplink and downlink PRBs based on an intersection between the uplink/downlink subband and the active uplink/downlink BWP in SBFD symbols. Alternatively, the network entity 102 may configure the UE 104 with an indication of the usable PRBs within the active coupled BWP in SBFD symbols.

In certain aspects, because the active BWPs are coupled (e.g., the uplink BWP and the downlink BWP share a center frequency), one way to increase the usable uplink and downlink PRBs is to increase the bandwidth of the active BWPs (e.g., increase the bandwidth of one or more of the uplink and downlink BWPs). However, this may require that the UE 104 monitor and decode signaling received from the increased bandwidth, thereby increasing power consumption at the UE 104. Thus, certain aspects of the disclosure are directed to decoupling the BWPs so that active downlink and uplink BWPs may be arranged to maximize usable PRBs without increasing the bandwidth of the active BWPs beyond what is necessary. Thus, the UE 104 may operate with an activated uplink BWP and downlink BWP with different center frequencies during communications in SBFD symbols.

For example, a coupled pair of uplink and downlink BWPs share a fixed center frequency. Thus, increasing the bandwidth of the downlink BWP may cause the downlink BWP bandwidth to include all or a portion of the uplink subband (e.g., uplink subband 818 of FIG. 8). Moreover, increasing the bandwidth of the uplink BWP may cause the uplink BWP bandwidth to include all or a portion of one or both downlink subbands (e.g., the first downlink subband 816 and second downlink subband 820). Thus, such increases may result in the UE 104 and network entity 102 monitoring and/or using bandwidths from which no signaling is expected.

### Examples of Bandwidth Part (BWP) Decoupling for Sub-Band Full-Duplex (SBFD) Communications

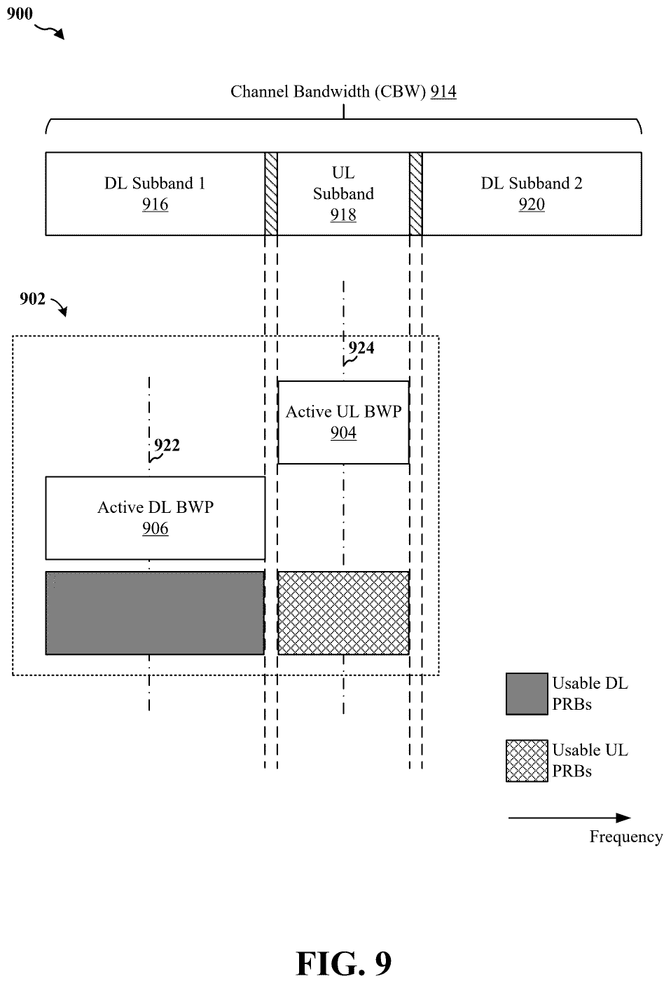

FIG. 9 is a block diagram illustrating an example 900 of usable physical resource blocks (PRB) of a decoupled BWP pair 902 located within SBFD symbols. Here, a channel bandwidth (CBW) 914 used for communication between a UE 104 and a network entity 102 during SBFD symbols is divided into three subbands: a first downlink subband 916, an uplink subband 918, and a second downlink subband 920. As illustrated, an x-axis advances to the right in terms of frequency. The y-axis is unitless because FIG. 9 illustrates an example of usable PRBs for given BWPs; however, the usable PRBs and active BWPs that are illustrated represent a bandwidth division at a given time instance. The SBFD symbols of this examples may form a portion of a TDD slot or an entire TDD slot. The decoupled BWP pair 902 illustrated is described herein as “decoupled” because the active uplink BWP 904 and the active downlink BWP 906 that form the BWP pair do not share a common center frequency.

Here, when the UE 104 is communicating with a network entity 102, the UE 104 may use the decoupled BWP pair 902 as the active BWPs for transmitting and receiving wireless signaling during SBFD symbols. In this example, the decoupled BWP pair 902 includes: (i) an active uplink BWP 904 having a center frequency 924 that falls within the uplink subband 918, and (ii) an active downlink BWP 906 having a center frequency 922 that falls within the first downlink subband 916. As illustrated, both the active uplink BWP 904 and the active downlink BWP 906 occupy the entire frequency range of their respective subbands and do not use common center frequencies. As such, all or mostly all PRBs associated with each of the active uplink BWP 904 and the active downlink BWP 906 are usable for transmitting uplink signaling and receiving downlink signaling. This represents a significant improvement in communication and efficient power usage relative to the examples illustrated in FIGS. 7 and 8.

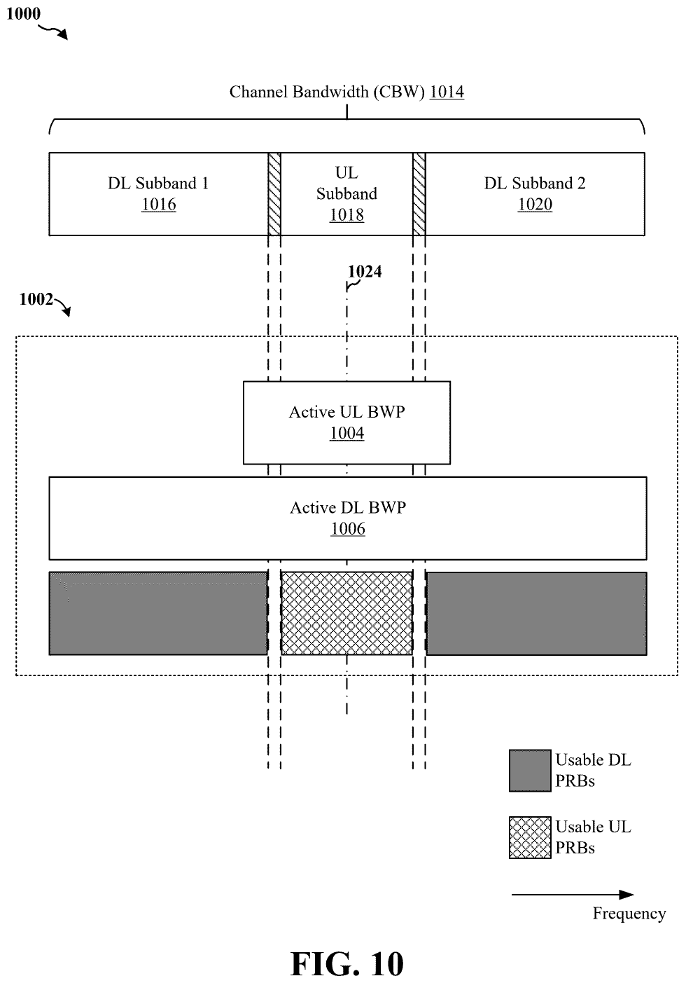

FIG. 10 is a block diagram illustrating an example 1000 of usable physical resource blocks (PRB) of a coupled BWP pair 1002 located within SBFD symbols. The coupled BWP pair 1002 illustrated is described herein as “coupled” because the active uplink BWP 1004 and the active downlink BWP 1006 that form the coupled BWP pair 1002 share a common center frequency 1024. Here, a channel bandwidth (CBW) 1014 used for communication between a UE 104 and a network entity 102 during SBFD symbols is divided into three subbands: a first downlink subband 1016, an uplink subband 1018, and a second downlink subband 1020. As illustrated, an x-axis advances to the right in terms of frequency. The y-axis is unitless because FIG. 10 illustrates an example of usable PRBs for given BWPs; however, the usable PRBs and active BWPs that are illustrated represent a bandwidth division at a given time instance. The SBFD symbols of this example may form a portion of a TDD slot or an entire TDD slot.

Here, when the UE 104 is communicating with a network entity 102, the UE 104 may use the coupled BWP pair 1002 as the active BWP for transmitting and receiving wireless signaling during SBFD symbols. In this example, the coupled BWP pair 1002 includes: (i) an active uplink BWP 1004, and (ii) an active downlink BWP 1006, both having a common center frequency 1024. As illustrated, both the active uplink BWP 1004 and the active downlink BWP 1006 occupy the entire frequency range of their respective subbands in order to maximize usable PRBs associated with uplink and downlink communications. As such, all or mostly all PRBs associated with each of the active uplink BWP 1004 and the active downlink BWP 1006 are usable for transmitting uplink signaling and receiving downlink signaling. This represents a significant improvement in communication and efficient power usage relative to the examples illustrated in FIGS. 7 and 8.

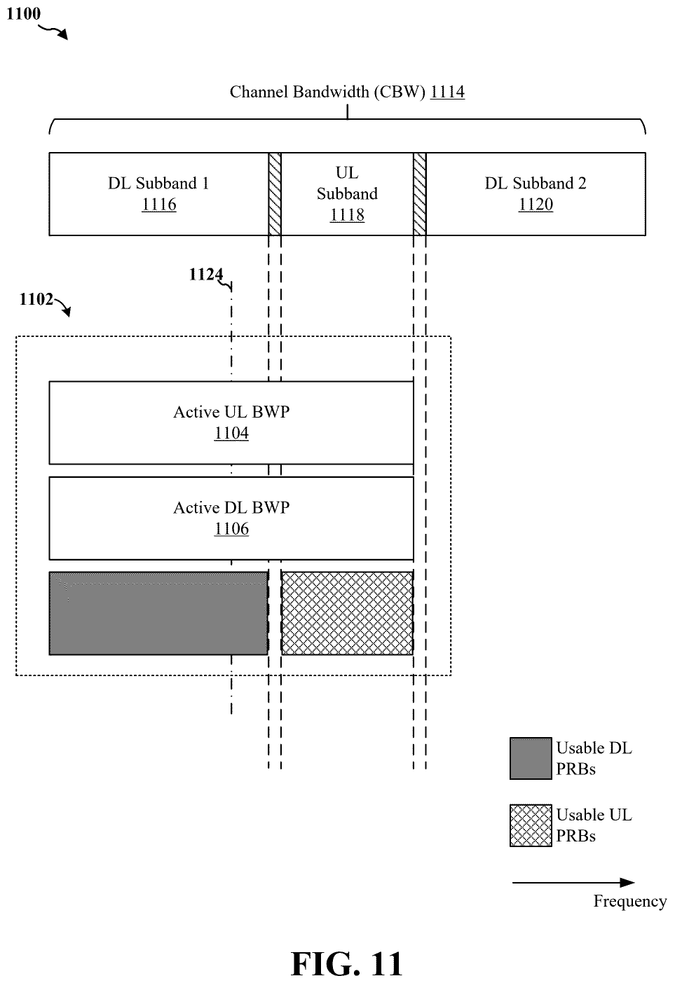

FIG. 11 is a block diagram illustrating an example 1100 of usable physical resource blocks (PRB) of a coupled BWP pair 1102 located within SBFD symbols. The coupled BWP pair 1102 illustrated is described herein as “coupled” because the active uplink BWP 1104 and the active downlink BWP 1106 that form the coupled BWP pair 1102 share a common center frequency 1124. Here, a channel bandwidth (CBW) 1114 used for communication between a UE 104 and a network entity 102 during SBFD symbols is divided into three subbands: a first downlink subband 1116, an uplink subband 1118, and a second downlink subband 1120. As illustrated, an x-axis advances to the right in terms of frequency. The y-axis is unitless for the same reasons described above in reference to FIG. 10.

Here, when the UE 104 is communicating with a network entity 102, the UE 104 may use the coupled BWP pair 1102 as the active BWP for transmitting and receiving wireless signaling during SBFD symbols. In this example, the coupled BWP pair 1102 includes: (i) an active uplink BWP 1104, and (ii) an active downlink BWP 1106, both having a common center frequency 1124. As illustrated, the active uplink BWP 1104 occupies the entire uplink subband 1118, and the active downlink BWP 1106 occupies half the available downlink frequency range (e.g., just the first downlink subband 1116). It should be noted that the downlink BWP 1106 has a smaller bandwidth relative to the downlink BWP of FIG. 10. While this may reduce the number of usable PRBs available to the UE 104 and network entity 102. This represents a significant improvement in communication and efficient power usage relative to the examples illustrated in FIGS. 7 and 8.

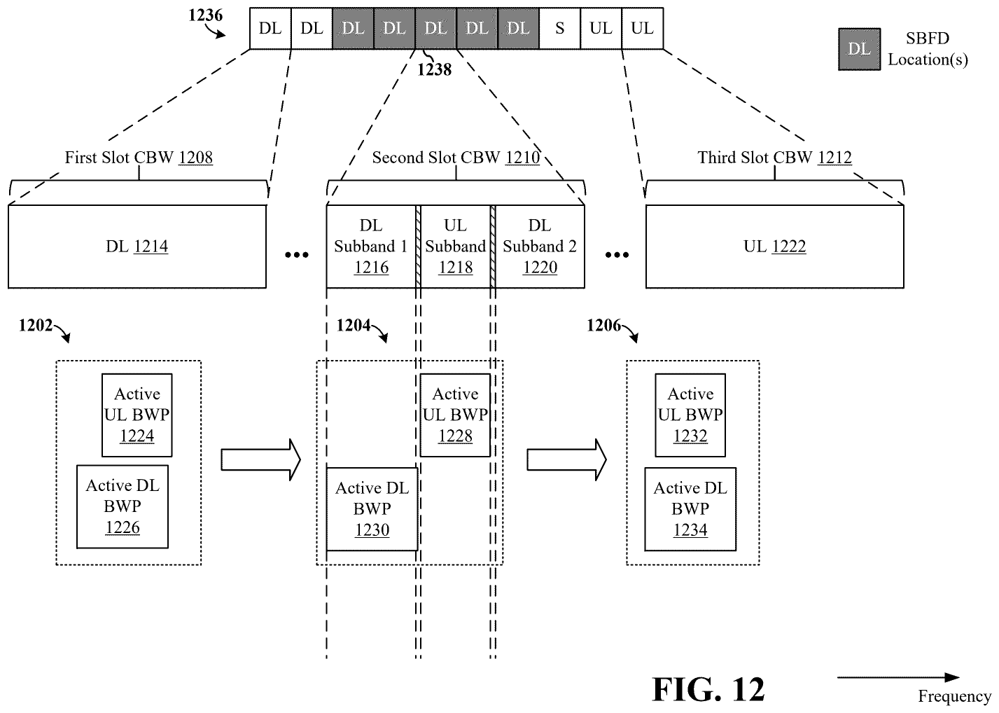

FIG. 12 is a block diagram illustrating an example TDD pattern 1236 within which a UE 104 and network entity 102 may modify or change BWPs based on whether a corresponding TDD slot is a downlink, uplink, or SBFD slot. The network entity 102 may configure the UE 104 with the TDD pattern 1236. In this example, the TDD pattern 1236 is a contiguous 10-slot pattern with the first seven slots being allocated for downlink transmission, an eighth slot being allocated to a guard band or a special slot, and the ninth and tenth slots being allocated for uplink. Without further configuration, the 10-slot pattern may be comprised of non-SBFD slots. However, the network entity 102 may further configure the UE 104 with an indication that the third through seventh slots in the pattern are SBFD locations. That is, downlink slots 3-7 may be split into different subbands for SBFD communications.

From the TDD pattern 1236, each of a first slot 1214, a second slot 1238, and a third slot 1222 are expanded into a more detailed view with corresponding BWP pairs used by the UE 104 and network entity 102 for communication within the respective slots. The first slot 1214 is configured as a non-SBFD downlink slot having a first CBW 1208. The UE 104 and network entity 102 may communicate within the first slot 1214 via a first BWP pair 1202 having a first uplink BWP 1224 and a first downlink BWP 1226.

The second slot 1238 may initially be configured as a non-SBFD downlink slot having a second CBW 1210, but the network entity 102 may turn the second slot 1238 into an SBFD location. Thus, in this example, the second slot 1238 is partitioned into three subbands: a first downlink subband 1216, an uplink subband 1218, and a second downlink subband 1220, all of which form portions of the second CBW 1210. Each subband may be separated from another subband by a guard band (illustrated with hashed lines between the first downlink subband 1216 and the uplink subband 1218, and between the uplink subband 1218 and the second downlink subband 1220). The UE 104 and network entity 102 may communicate within the second slot 1238 via a second BWP pair 1204 having a second uplink BWP 1228 and a second downlink BWP 1230. Here, the second uplink BWP 1228 may be in the same frequency location and have the same number of PRBs as the first uplink BWP 1224. Thus, the UE 104 may use the same uplink BWPs in the first slot 1214 and the second slot 1238. In contrast, the UE 104 may switch from the first downlink BWP 1226 to the second downlink BWP 1230 to improve its ability to receive downlink communications. This is because the location of the first downlink BWP 1226 would be substantially in the uplink subband 1218 of the second slot 1238 and thus downlink communications would be hindered. Note that the respective BWPs of the first BWP pair 1202 and the second BWP pair 1204 are illustrated as decoupled BWPs. While it may be advantageous for the second BWP pair 1204 to include decoupled BWPs in order to efficiently monitor the downlink and/or transmit on the uplink, the first BWP pair 1202 may be a coupled BWP, in some examples.

The third slot 1222 is configured as a non-SBFD uplink slot having a third CBW 1212. The UE 104 and network entity 102 may communicate within the third slot 1222 via a third BWP pair 1206 having a third uplink BWP 1232 and a third downlink BWP 1234. Although the third BWP pair 1206 is illustrated as a coupled BWP pair, the pair may be a decoupled pair (e.g., the UE 104 may even use the second BWP pair 1204 instead of the third BWP pair 1206 for the third slot 1222). Here, the third downlink BWP 1234 may be in the same frequency location and have the same number of PRBs as the second downlink BWP 1230. Thus, the UE 104 may use the same downlink BWPs in the second slot 1238 and the third slot 1222. As illustrated, the UE 104 may switch from the second uplink BWP 1228 to the third uplink BWP 1232. In certain aspects, the switching of one or more BWPs across slots may be referred to as “BWP hopping.” It should be noted that in some examples, the first CBW 1208, the second CBW 1210, and the third CBW 1212 are all the same size (e.g., same channel bandwidth or frequency range).

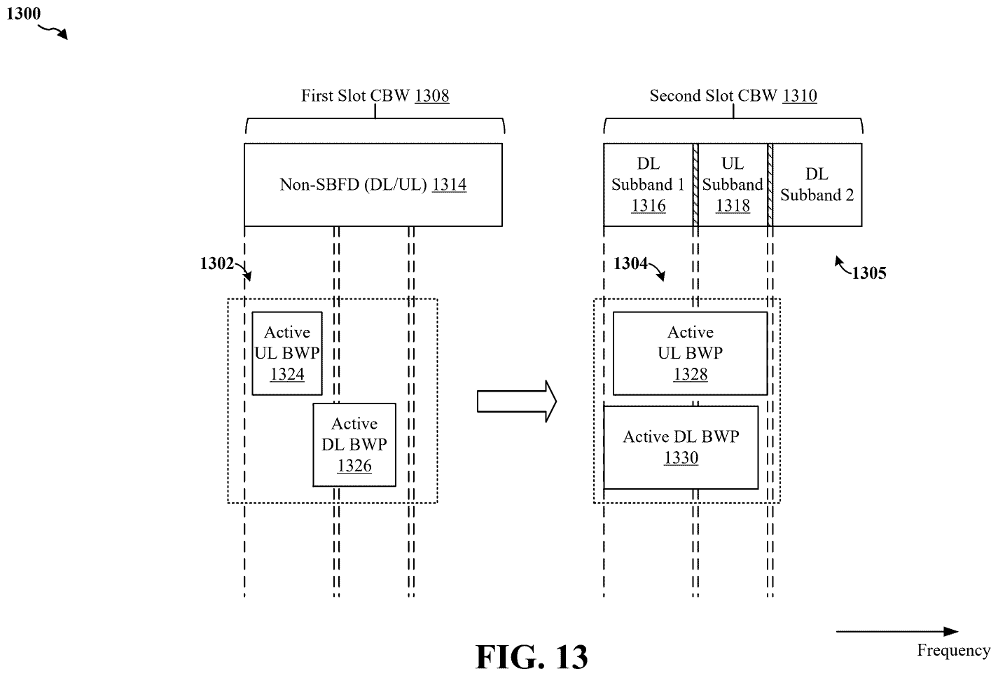

FIG. 13 is a block diagram illustrating an example 1300 of BWP expansion between SBFD slot 1305 and a non-SBFD slot(s) 1314. The non-SBFD slot 1314 may be associated with a first slot CBW 1308, and the SBFD slot 1305 may be associated with a second slot CBW 1310. In some examples, the first slot CBW 1308 is equal to the second slot CBW 1310.

The UE 104 may be configured with and use a coupled or decoupled BWP pair for communication via non-SBFD slots. However, the non-SBFD BWP pair may not provide for efficient communications during SBFD slots. Thus, in some examples, the UE 104 may be configured to expand the bandwidth of one or more of the uplink BWP and/or the downlink BWP of the same BWP pair to improve communications within an SBFD slot.

For example, the UE 104 and network entity 102 may communicate via a first BWP pair 1302 during one or more non-SBFD slots 1314. Although the first BWP pair 1302 is illustrated as a decoupled BWP pair for purposes of explanation, the first BWP pair 1302 may also be implemented as a coupled BWP pair. Here, the first BWP pair 1302 include a first uplink BWP 1324 and a first downlink BWP 1326 that the UE 104 and network entity 102 may use or communication across multiple non-SBFD slots or symbols.

In the illustrated example, the UE 104 may expand the bandwidth of the first uplink BWP 1324 to the right (maintaining the left-most position of the first uplink BWP 1324) into the uplink subband 1318, resulting in a second uplink BWP 1328. The UE 104 may also expand the bandwidth of the first downlink BWP 1326 to the left (maintaining the right-most position of the first downlink BWP 1326) into the first downlink subband 1316, resulting in a second downlink BWP 1330, and a second BWP pair 1304. Accordingly, the uplink and downlink communications may be improved by expanding the BWPs into corresponding subbands to increase the usable PRBs of each BWP.

It should be noted that the UE may expand the bandwidth of a BWP in one or both directions, and the BWP expansion may be limited by the channel bandwidth (e.g., first slot CBW 1308 and/or second slot CBW 1310).

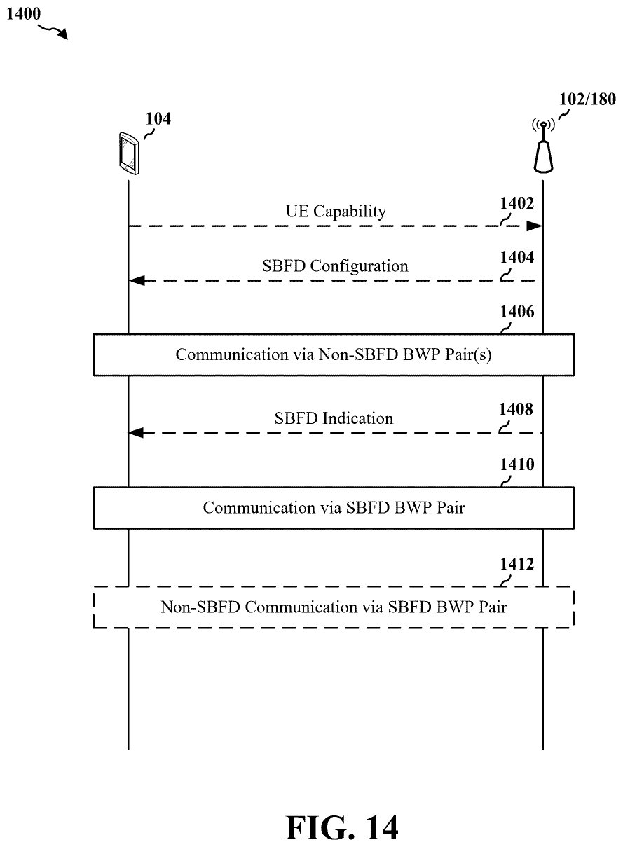

FIG. 14 is a call-flow diagram illustrating example communications 1400 between a UE 104 and a network entity 102.

Initially, at an optional first communication 1402, the UE 104 may transmit to the network entity 102 an indication of its capability to switch between BWP pairs in in response to changes from SBFD symbols and non-SBFD resources. In some examples, such a switch may include switching to a decoupled BWP pair during SBFD symbols to facilitate communications between the UE 104 and network entity 102. In some examples, the UE 104 may transmit the indication to the network entity 102 via PUCCH (e.g., uplink control information (UCI)) or any other suitable means for transmitting the indication of UE capability.

In some examples, the capability indication may include an indication of whether the UE 104 is capable of communicating via a decoupled BWP pair only during SBFD symbols or both SBFD and non-SBFD symbols. The capability indication may include an indication of a maximum bandwidth of decoupled BWPs supported by the UE 104. For example, the UE 104 may indicate that it can support up to X PRBs for a downlink BWP and/or Y PRBs for an uplink BWP. The capability indication may include an indication of a maximum and/or minimum separation between the center frequencies of the downlink BWP and uplink BWP of the decoupled BWP pair. In some examples, the capability indication may include an indication of whether the UE 104 can support BWP hopping between different BWPs and/or BWP expansion/contraction. For example, the UE 104 may support “hopping” from one BWP of a BWP pair to another BWP. That is, the UE 104 may switch from a current uplink or downlink BWP of a BWP pair to a different uplink or downlink BWP. In another example, the UE 104 may support expanding and/or contracting the bandwidth of a BWP. In either example, the hopping or expansion/contraction may occur or be triggered by a switch from non-SBFD symbols to SBFD symbols and vice versa.

Alternatively, at the optional first communication 1402, the UE 104 may transmit to the network entity 102 an indication of its capability to switch between BWP pairs in in response to changes from SBFD symbols and non-SBFD resources. In some examples, such a switch may include changing from a first coupled BWP pair used to communicate during non-SBFD symbols to a second coupled BWP pair used to communicate during SBFD symbols. In some examples, the UE may transmit the indication to the network entity 102 via PUCCH (e.g., uplink control information (UCI)) or any other suitable means for transmitting the indication of UE capability.

As discussed, the capability indication may indicate that the UE 104 has the capability to switch between BWP pairs for SBFD and non-SBFD communications. In some examples, the capability indication may include an indication that the UE 104 is capable of communicating via one or active BWPs of an active coupled BWP pair having a relatively wider bandwidth (e.g., as illustrated in FIGS. 10 and 11) than one or more active BWPs typically used for communications via non-SBFD resources. In some examples, the UE 104 may indicate that it is capable of being configured with multiple BWP pairs, including one or more BWP pairs for communication via SBFD symbols, and another one or more BWP pairs for communication via non-SBFD symbols.

In some examples, the capability indication may indicate that the UE 104 is capable of switching between different BWP pairs in response to the network entity 102 transmitting an explicit indication of a switch from current SBFD or non-SBFD symbols to the other of the SBFD or non-SBFD symbols. In another example, the capability indication may indicate that the UE 104 is capable of being implicitly triggered to switch between different BWP pairs based on the UE 104 being aware of an upcoming change from current SBFD or non-SBFD symbols to the other of the SBFD or non-SBFD symbols. In this example, the network entity 102 may configure the UE 104 with an indication of which resources are SBFD resources and which resources are non-SBFD so that the UE 104 can determine whether to switch from one BWP pair to another BWP pair in response to such a change in resources, as discussed in further detail below in reference to an optional second communication 1404.

At an optional second communication 1404, the network entity 102 may transmit one or more SBFD configuration message(s) to the UE 104. Such messages may be transmitted via one or more of a system information block (SIB), an RRC (re-) configuration message, a downlink control information (DCI) message, and/or a medium access control-control element (MAC-CE).

An SBFD configuration message may include an indication of one or more coupled/decoupled BWP pairs that the UE 104 may use for communication with the network entity (e.g., base station 102/180), as well as an indication of whether each pair may be used during SBFD and/or non-SBFD symbols. In some examples, the SBFD configuration message may include at least one indication of a BWP pair (e.g., a decoupled BWP pair) for use during SBFD symbols. In some examples, the SBFD configuration message may also indicate one or more alternative uplink and/or downlink BWPs that may be used to replace another BWP in a BWP pair. In some examples, the UE 104 may keep one BWP of a current active BWP pair active while replacing the other BWP of the current BWP pair with a different BWP (e.g., a BWP with a wider bandwidth than the BWP being replaced).

In some examples, the SBFD configuration message may configure the UE 104 to perform a BWP pair switch, a single BWP switch (e.g., BWP hopping), or BWP expansion/contraction in response to an explicit notification from the network entity 102. For example, the network entity 102 may transmit a DCI, RRC, MAC-CE, or any other suitable messaging format to the UE 104 indicating a future change from SBFD to non-SBFD symbols, or non-SBFD to SBFD symbols, prior to the change (e.g., one or more slots prior to the change). In some examples, the SBFD configuration message may indicate separate offset values to the UE 104 for SBFD BWPs and non-SBFD BWPs. For example, the offset values may be frequency offsets or PRB offsets (e.g., RBstart, OffsetToCarrier, etc.) measured in relation to a boundary of the channel bandwidth. In another example, the SBFD configuration message may include an indication of a center frequency associated with each BWP and/or BWP pair. In some examples, the SBFD configuration message may indicate the extent to which the UE 104 may expand an existing or current BWP. Here, the SBFD configuration message may configure the UE 104 to expand a BWP to a maximum or minimum ratio of usable PRBs.

In some examples, the SBFD configuration may indicate a TDD pattern and/or which slots of a TDD pattern are configured as non-SBFD and which slots are configured as SBFD. In some examples, when the pattern is configured, the SBFD configuration may indicate a period of SBFD symbols within the pattern. Thus, with each contiguous repetition of the TDD pattern, the same indicated symbols may be used for SBFD communications. Alternatively, the period may be indicated with an integer multiplier. Here, the integer multiplier may be used by the UE 104 to indicate which repetitions of the TDD pattern have the indicated SBFD symbols. For example, if the multiplier is 2, then the SBFD period may exist in every second instance of the TDD pattern. Thus, one TDD pattern without the SBFD period, then the next TDD pattern with the SBFD period, then the immediately following TDD pattern without the SBFD period, and so on.

In some examples, the SBFD configuration may configure the UE 104 to switch implicitly based on the TDD pattern and period of SBFD symbols within the pattern. In this example, one configured, the UE 104 may automatically switch from one BWP pair to another BWP pair in response to an upcoming change from non-SBFD symbols to SBFD symbols, or vice versa. In some examples, the SBFD configuration may configure the UE 104 to implicitly switch (e.g., automatically switch from one BWP pair to another without messaging from the network entity 102) in response to a change from non-SBFD to SBFD, but not switch the BWP pair used for communicating during the SBFD symbols when the symbols change back to non-SBFD. In this case, the UE 104 may wait for an explicit command from the network entity 102 before switching back to the previous BWP pair or to a BWP pair identified by the explicit command.

In some examples, the SBFD configuration may configure the UE 104 with a timer having a duration. The UE 104 may start the timer when it switches a BWP pair in response to an SBFD to non-SBFD or non-SBFD to SBFD transition. The UE 104 may use the same BWP pair for the duration of the timer. At the end of the timer, the UE 104 may switch back to the previously used BWP pair.

At a third communication 1406, the UE 104 and network entity 102 may communicate via one or more coupled or uncoupled BWP pair(s) via non-SBFD symbols. In some examples, the one or more coupled or uncoupled BWP pair(s) may be configured at the UE 104 via the SBFD communication message of the optional second communication 1404.

At an optional fourth communication 1408, the network entity 102 may transmit an indication of a future change from non-SBFD communications to SBFD communications. Based on this communication, the UE 104 may change from a non-SBFD BWP pair to an SBFD BWP pair, change one BWP of a current non-SBFD BWP pair, or expand the bandwidth of one or more of the uplink and/or downlink BWP of a current BWP pair, in order to improve communications with the network entity 102 during SBFD symbols. In some examples, the SBFD BWP pair may include one or more BWPs having a wider bandwidth than a corresponding BWP of the non-SBFD BWP pair.

At a fifth communication 1410, the UE 104 and the network entity 102 may communicate via the SBFD BWP pair. At an optional sixth communication 1412, the UE 104 and the network entity 102 may continue to communicate after a switch back from SBFD symbols to non-SBFD symbols. In some examples, the UE 104 and network entity 102 may to use the same one or more BWPs of a BWP pair used during the SBFD symbols.

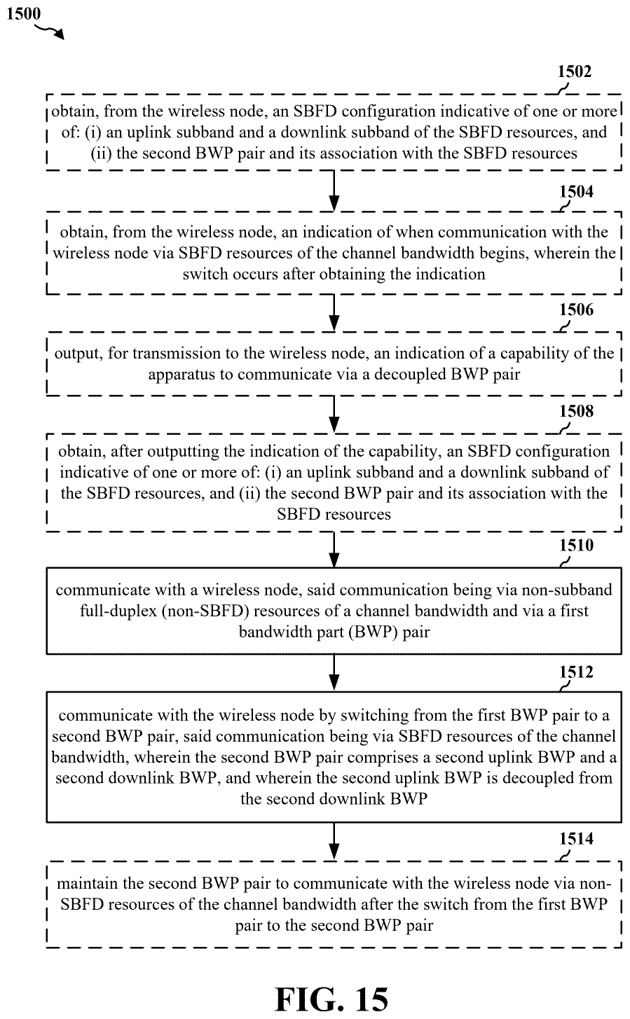

FIG. 15 is a flowchart 1500 of a method of wireless communication. The method may be performed by a UE (e.g., the UE 104; the apparatus 1602). Specifically, the method may be performed by one or more memories, processors, and RF front ends (e.g., the memory 360, controller/processor 359, transmitter 354TX, receiver 354RX, antenna 352, etc., of FIG. 3).

At 1502, the UE may optionally obtain, from a wireless node, an SBFD configuration indicative of one or more of: (i) an uplink subband and a downlink subband of the SBFD resources, and (ii) the second BWP pair and its association with the SBFD resources. For example, 1502 may be performed by an obtaining component 1640.

At 1504, the UE may optionally obtain, from the wireless node, an indication of when communication with the wireless node via SBFD resources of the channel bandwidth begins, wherein the switch occurs after obtaining the indication. For example, 1504 may be performed by the obtaining component 1640.

At 1506, the UE may optionally output, for transmission to the wireless node, an indication of a capability of the apparatus to communicate via a decoupled BWP pair. For example, 1506 may be performed by an outputting component 1642.

At 1508, the UE may optionally obtain, after outputting the indication of the capability, an SBFD configuration indicative of one or more of: (i) an uplink subband and a downlink subband of the SBFD resources, and (ii) the second BWP pair and its association with the SBFD resources. For example, 1508 may be performed by the obtaining component 1640.

At 1510, the UE may communicate with a wireless node, said communication being via non-subband full-duplex (non-SBFD) resources associated with a channel bandwidth and via a first bandwidth part (BWP) pair. For example, 1510 may be performed by the obtaining component 1640 and the outputting component 1642.

At 1512, the UE may communicate with the wireless node by switching from the first BWP pair to a second BWP pair, said communication being via SBFD resources associated with the channel bandwidth, wherein the second BWP pair comprises a second uplink BWP and a second downlink BWP, and wherein the second uplink BWP is decoupled from the second downlink BWP. For example, 1512 may be performed by the obtaining component 1640 and the outputting component 1642.

At 1514, UE may optionally maintain the second BWP pair to communicate with the wireless node via non-SBFD resources of the channel bandwidth after the switch from the first BWP pair to the second BWP pair. For example, 1514 may be performed by a maintaining component 1644.

In certain aspects, the second uplink BWP comprises less than or equal to X physical resource blocks (PRBs); and the second downlink BWP comprises less than or equal to Y PRBs.

In certain aspects, the SBFD resources comprise a downlink subband and an uplink subband; X is equal to a first number of PRBs within the uplink subband; and Y is equal to a second number of PRBs within the downlink subband.

In certain aspects, the SBFD configuration is further indicative of at least one of: the second uplink BWP being contained within the uplink subband; or the second downlink BWP being contained within the downlink subband.

In certain aspects, at least one of: the second downlink BWP satisfies a first ratio of usable downlink physical resource blocks (PRBs) in the second downlink BWP to total downlink PRBs in the second downlink BWP; or the second uplink BWP satisfies a second ratio of usable uplink PRBs in the second uplink BWP to total uplink PRBs in the second uplink BWP.

In certain aspects, the usable downlink PRBs are resources of the second downlink BWP that overlap with resources of the downlink subband; and the usable uplink PRBs are resources of the second downlink BWP that overlap with resources of the uplink subband.

In certain aspects, the indication of the second BWP pair comprises at least one of: a first offset value indicating a first starting frequency of the second uplink BWP relative to a starting frequency of the channel bandwidth; or a second offset value indicating a second starting frequency of the second downlink BWP relative to the starting frequency of the channel bandwidth.

In certain aspects, the first the BWP pair comprises a first uplink BWP coupled to a first downlink BWP; the first offset value is different from a third offset value indicating a third starting frequency of the first uplink BWP; and the second offset value is different from a fourth offset value indicating a fourth starting frequency of the first downlink BWP.

In certain aspects, the first the BWP pair comprises a first uplink BWP coupled to a first downlink BWP, and wherein at least one of: the first uplink BWP is associated with a first center frequency different from a second center frequency associated with the second uplink BWP; or the first downlink BWP is associated with a third center frequency different from a fourth center frequency associated with the second downlink BWP.

In certain aspects, the first the BWP pair comprises a first uplink BWP coupled to a first downlink BWP, and wherein at least one of: the first uplink BWP and the second uplink BWP both occupy a first number of physical resource blocks (PRBs); or the first downlink BWP and the second downlink BWP both occupy a second number of PRBs.

In certain aspects, the first the BWP pair comprises a first uplink BWP coupled to a first downlink BWP, and wherein at least one of: the second uplink BWP comprises the first uplink BWP with expanded bandwidth; or the second downlink BWP comprises the first downlink BWP with expanded bandwidth.

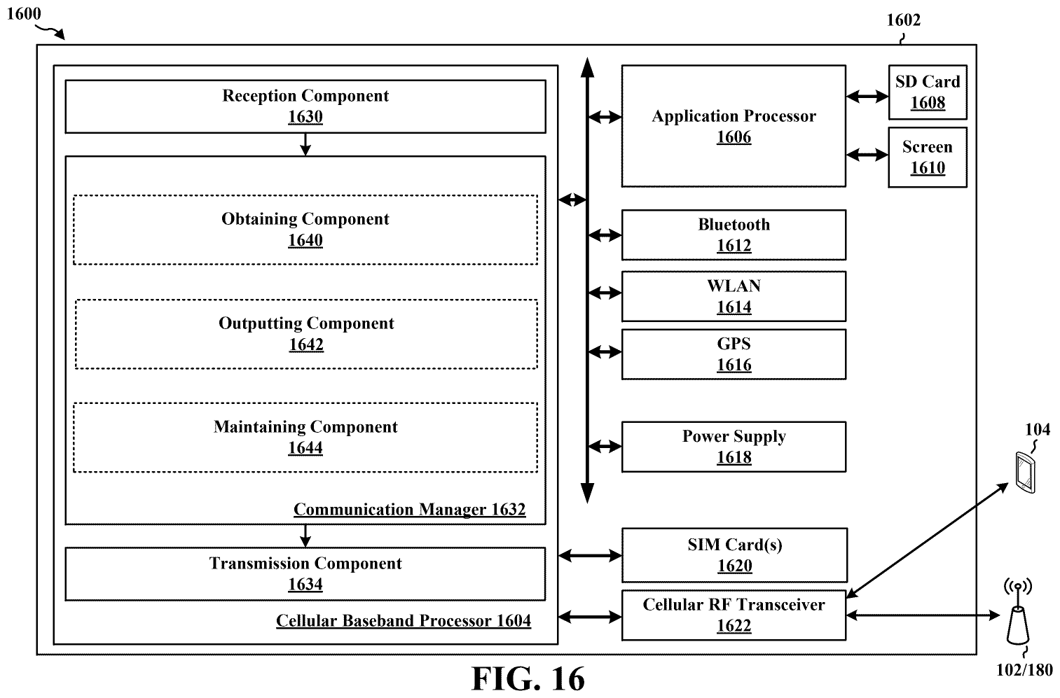

FIG. 16 is a diagram 1600 illustrating an example of a hardware implementation for an apparatus 1602. The apparatus 1602 is a UE and includes a cellular baseband processor 1604 (also referred to as a modem) coupled to a cellular RF transceiver 1622 and one or more subscriber identity modules (SIM) cards 1620, an application processor 1606 coupled to a secure digital (SD) card 1608 and a screen 1610, a Bluetooth module 1612, a wireless local area network (WLAN) module 1614, a Global Positioning System (GPS) module 1616, and a power supply 1618. The cellular baseband processor 1604 communicates through the cellular RF transceiver 1622 with the UE 104 and/or BS 102/180. The cellular baseband processor 1604 may include a computer-readable medium/memory. The computer-readable medium/memory may be non-transitory. The cellular baseband processor 1604 is responsible for general processing, including the execution of software stored on the computer-readable medium/memory. The software, when executed by the cellular baseband processor 1604, causes the cellular baseband processor 1604 to perform the various functions described supra. The computer-readable medium/memory may also be used for storing data that is manipulated by the cellular baseband processor 1604 when executing software. The cellular baseband processor 1604 further includes a reception component 1630, a communication manager 1632, and a transmission component 1634. The communication manager 1632 includes the one or more illustrated components. The components within the communication manager 1632 may be stored in the computer-readable medium/memory and/or configured as hardware within the cellular baseband processor 1604. The cellular baseband processor 1604 may be a component of the UE 104 and may include the memory 360 and/or at least one of the TX processor 368, the RX processor 356, and the controller/processor 359. In one configuration, the apparatus 1602 may be a modem chip and include just the baseband processor 1604, and in another configuration, the apparatus 1602 may be the entire UE (e.g., see UE 104 of FIG. 3) and include the aforediscussed additional modules of the apparatus 1602. In various examples, the apparatus 1602 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

The communication manager 1632 includes an obtaining component 1640 that is configured to obtain, from the wireless node, an SBFD configuration indicative of one or more of: (i) an uplink subband and a downlink subband of the SBFD resources, and (ii) the second BWP pair and its association with the SBFD resources; obtain, from the wireless node, an indication of when communication with the wireless node via SBFD resources of the channel bandwidth begins, wherein the switch occurs after obtaining the indication; obtain, after outputting the indication of the capability, an SBFD configuration indicative of one or more of: (i) an uplink subband and a downlink subband of the SBFD resources, and (ii) the second BWP pair and its association with the SBFD resources; communicate with a wireless node, said communication being via non-subband full-duplex (non-SBFD) resources associated with a channel bandwidth and via a first bandwidth part (BWP) pair; communicate with the wireless node by switching from the first BWP pair to a second BWP pair, said communication being via SBFD resources associated with the channel bandwidth, wherein the second BWP pair comprises a second uplink BWP and a second downlink BWP, and wherein the second uplink BWP is decoupled from the second downlink BWP; e.g., as described in connection with 1502, 1504, 1508, 1510, and 1512 of FIG. 15.

The communication manager 1632 further includes an outputting component 1642 configured to output, for transmission to the wireless node, an indication of a capability of the apparatus to communicate via a decoupled BWP pair; communicate with a wireless node, said communication being via non-subband full-duplex (non-SBFD) resources associated with a channel bandwidth and via a first bandwidth part (BWP) pair; communicate with the wireless node by switching from the first BWP pair to a second BWP pair, said communication being via SBFD resources associated with the channel bandwidth, wherein the second BWP pair comprises a second uplink BWP and a second downlink BWP, and wherein the second uplink BWP is decoupled from the second downlink BWP; e.g., as described in connection with 1506, 1510, and 1512 of FIG. 15.

The communication manager 1632 further includes a maintaining component 1644 configured to maintain the second BWP pair to communicate with the wireless node via non-SBFD resources of the channel bandwidth after the switch from the first BWP pair to the second BWP pair, e.g., as described in connection with 1514 of FIG. 15.

The apparatus may include additional components that perform each of the blocks of the algorithm in the aforementioned flowchart of FIG. 15. As such, each block in the aforementioned flowchart may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1602, and in particular the cellular baseband processor 1604, includes: means for obtaining, from the wireless node, an SBFD configuration indicative of one or more of: (i) an uplink subband and a downlink subband of the SBFD resources, and (ii) the second BWP pair and its association with the SBFD resources; means for obtaining, from the wireless node, an indication of when communication with the wireless node via SBFD resources of the channel bandwidth begins, wherein the switch occurs after obtaining the indication; means for outputting, for transmission to the wireless node, an indication of a capability of the apparatus to communicate via a decoupled BWP pair; means for obtaining, after outputting the indication of the capability, an SBFD configuration indicative of one or more of: (i) an uplink subband and a downlink subband of the SBFD resources, and (ii) the second BWP pair and its association with the SBFD resources; means for communicating with a wireless node, said communication being via non-subband full-duplex (non-SBFD) resources associated with a channel bandwidth and via a first bandwidth part (BWP) pair; means for communicating with the wireless node by switching from the first BWP pair to a second BWP pair, said communication being via SBFD resources associated with the channel bandwidth, wherein the second BWP pair comprises a second uplink BWP and a second downlink BWP, and wherein the second uplink BWP is decoupled from the second downlink BWP; and means for maintaining the second BWP pair to communicate with the wireless node via non-SBFD resources of the channel bandwidth after the switch from the first BWP pair to the second BWP pair.

The aforementioned means may be one or more of the aforementioned components of the apparatus 1602 configured to perform the functions recited by the aforementioned means. As described supra, the apparatus 1602 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

Means for receiving or means for obtaining may include a receiver (such as the receive processor 356) and/or an antenna(s) 352 of the UE 104 illustrated in FIG. 3). Means for transmitting or means for outputting may include a transmitter (such as the transmit processor 368 or antenna(s) 352 of the UE 104 illustrated in FIG. 3). Means for communicating may include the means for receiving/obtaining and the means for outputting/transmitting. Means for maintaining and means for switching (e.g., means for switching a BWP) may include a processing system, which may include one or more processors, such as the controller/processor 359, the memory 360, and/or any other suitable hardware components of the UE 104 illustrated in FIG. 3.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

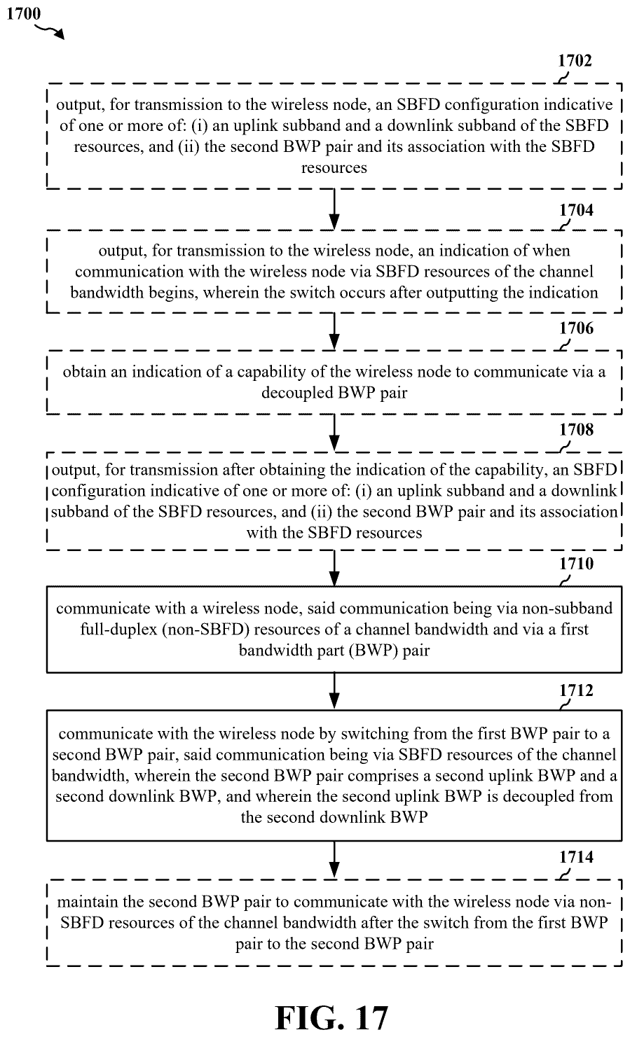

FIG. 17 is a flowchart 1700 of a method of wireless communication. The method may be performed by a network entity or base station (e.g., the base station 102/180; the apparatus 1602. Specifically, the method may be performed by one or more memories, processors, and RF front ends (e.g., the memory 376, controller/processor 375, transmitter 318TX, receiver 318RX, antenna 320, etc. of FIG. 3).

At 1702, the network entity may optionally output, for transmission to the wireless node, an SBFD configuration indicative of one or more of: (i) an uplink subband and a downlink subband of the SBFD resources, and (ii) the second BWP pair and its association with the SBFD resources. For example, 1702 may be performed by an outputting component 1840.

At 1704, the network entity may optionally output, for transmission to the wireless node, an indication of when communication with the wireless node via SBFD resources of the channel bandwidth begins, wherein the switch occurs after outputting the indication. For example, 1704 may be performed by the outputting component 1840.

At 1706, the network entity may optionally obtain an indication of a capability of the wireless node to communicate via a decoupled BWP pair. For example, 1706 may be performed by an obtaining component 1842.

At 1708, the network entity may optionally output, for transmission after obtaining the indication of the capability, an SBFD configuration indicative of one or more of: (i) an uplink subband and a downlink subband of the SBFD resources, and (ii) the second BWP pair and its association with the SBFD resources. For example, 1708 may be performed by the outputting component 1840.

At 1710, the network entity may communicate with a wireless node, said communication being via non-subband full-duplex (non-SBFD) resources associated with a channel bandwidth and via a first bandwidth part (BWP) pair. For example, 1710 may be performed by the outputting component 1840 and the obtaining component 1842.

At 1712, the network entity may communicate with the wireless node by switching from the first BWP pair to a second BWP pair, said communication being via SBFD resources associated with the channel bandwidth, wherein the second BWP pair comprises a second uplink BWP and a second downlink BWP, and wherein the second uplink BWP is decoupled from the second downlink BWP. For example, 1712 may be performed by the outputting component 1840 and the obtaining component 1842.

At 1714, the network entity may optionally maintain the second BWP pair to communicate with the wireless node via non-SBFD resources of the channel bandwidth after the switch from the first BWP pair to the second BWP pair. For example, 1714 may be performed by a maintaining component 1844.

In certain aspects, the second uplink BWP comprises less than or equal to X physical resource blocks (PRBs); and the second downlink BWP comprises less than or equal to Y PRBs.

In certain aspects, the SBFD resources comprise a downlink subband and an uplink subband; X is equal to a first number of PRBs within the uplink subband; and Y is equal to a second number of PRBs within the downlink subband.

In certain aspects, the SBFD configuration is further indicative of at least one of: the second uplink BWP being contained within the uplink subband; or the second downlink BWP being contained within the downlink subband.

In certain aspects, at least one of: the second downlink BWP satisfies a first ratio of usable downlink physical resource blocks (PRBs) in the second downlink BWP to total downlink PRBs in the second downlink BWP; or the second uplink BWP satisfies a second ratio of usable uplink PRBs in the second uplink BWP to total uplink PRBs in the second uplink BWP.

In certain aspects, the usable downlink PRBs are resources of the second downlink BWP that overlap with resources of the downlink subband; and the usable uplink PRBs are resources of the second downlink BWP that overlap with resources of the uplink subband.

In certain aspects, the indication of the second BWP pair comprises at least one of: a first offset value indicating a first starting frequency of the second uplink BWP relative to a starting frequency of the channel bandwidth; or a second offset value indicating a second starting frequency of the second downlink BWP relative to the starting frequency of the channel bandwidth.

In certain aspects, the first the BWP pair comprises a first uplink BWP coupled to a first downlink BWP; the first offset value is different from a third offset value indicating a third starting frequency of the first uplink BWP; and the second offset value is different from a fourth offset value indicating a fourth starting frequency of the first downlink BWP.

In certain aspects, the first the BWP pair comprises a first uplink BWP coupled to a first downlink BWP, and wherein at least one of: the first uplink BWP is associated with a first center frequency different from a second center frequency associated with the second uplink BWP; or the first downlink BWP is associated with a third center frequency different from a fourth center frequency associated with the second downlink BWP.

In certain aspects, the first the BWP pair comprises a first uplink BWP coupled to a first downlink BWP, and wherein at least one of: the first uplink BWP and the second uplink BWP both occupy a first number of physical resource blocks (PRBs); or the first downlink BWP and the second downlink BWP both occupy a second number of PRBs.

In certain aspects, the first the BWP pair comprises a first uplink BWP coupled to a first downlink BWP, and wherein at least one of: the second uplink BWP comprises the first uplink BWP with expanded bandwidth; or the second downlink BWP comprises the first downlink BWP with expanded bandwidth.

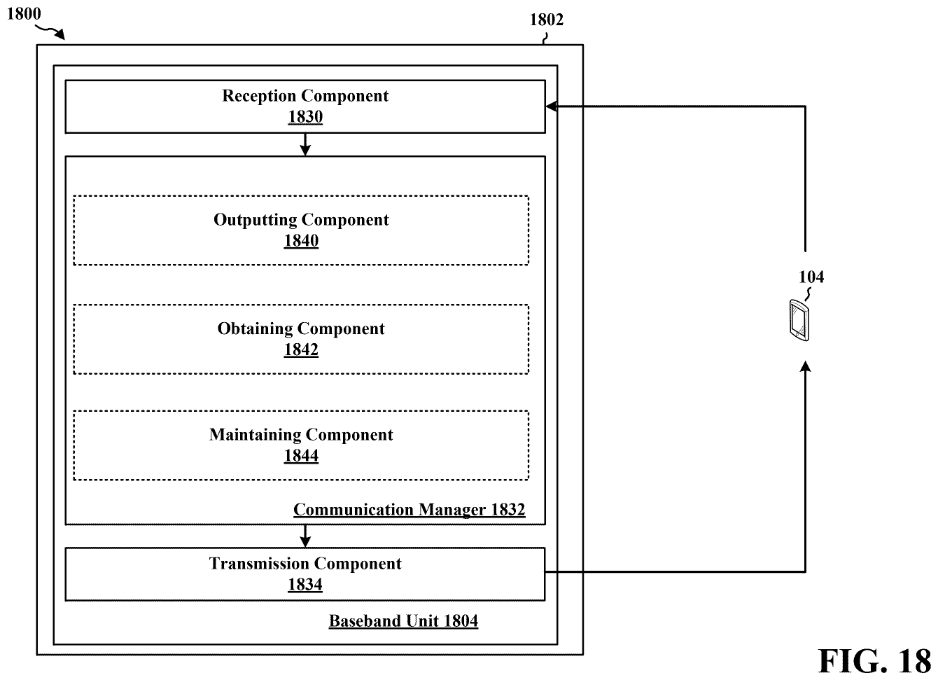

FIG. 18 is a diagram 1800 illustrating an example of a hardware implementation for an apparatus 1802. The apparatus 1802 is a network entity or base station and includes a baseband unit 1804. The baseband unit 1804 may communicate through a cellular RF transceiver with the UE 104. The baseband unit 1804 may include a computer-readable medium/memory. The baseband unit 1804 is responsible for general processing, including the execution of software stored on the computer-readable medium/memory. The software, when executed by the baseband unit 1804, causes the baseband unit 1804 to perform the various functions described supra. The computer-readable medium/memory may also be used for storing data that is manipulated by the baseband unit 1804 when executing software. The baseband unit 1804 further includes a reception component 1830, a communication manager 1832, and a transmission component 1834. The communication manager 1832 includes the one or more illustrated components. The components within the communication manager 1832 may be stored in the computer-readable medium/memory and/or configured as hardware within the baseband unit 1804. The baseband unit 1804 may be a component of the BS 102/180 and may include the memory 376 and/or at least one of the TX processor 316, the RX processor 370, and the controller/processor 375. In various examples, the apparatus 1802 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

The communication manager 1832 includes an outputting component 1840 configured to: output, for transmission to the wireless node, an SBFD configuration indicative of one or more of: (i) an uplink subband and a downlink subband of the SBFD resources, and (ii) the second BWP pair and its association with the SBFD resources; output, for transmission to the wireless node, an indication of when communication with the wireless node via SBFD resources of the channel bandwidth begins, wherein the switch occurs after outputting the indication; output, for transmission after obtaining the indication of the capability, an SBFD configuration indicative of one or more of: (i) an uplink subband and a downlink subband of the SBFD resources, and (ii) the second BWP pair and its association with the SBFD resources; communicate with a wireless node, said communication being via non-subband full-duplex (non-SBFD) resources associated with a channel bandwidth and via a first bandwidth part (BWP) pair; and communicate with the wireless node by switching from the first BWP pair to a second BWP pair, said communication being via SBFD resources associated with the channel bandwidth, wherein the second BWP pair comprises a second uplink BWP and a second downlink BWP, and wherein the second uplink BWP is decoupled from the second downlink BWP, e.g., as described in connection with 1702, 1704, 1708, 1710, and 1712 of FIG. 17.

The communication manager 1832 further includes an obtaining component 1842 configured to: obtain an indication of a capability of the wireless node to communicate via a decoupled BWP pair; communicate with a wireless node, said communication being via non-subband full-duplex (non-SBFD) resources associated with a channel bandwidth and via a first bandwidth part (BWP) pair; and communicate with the wireless node by switching from the first BWP pair to a second BWP pair, said communication being via SBFD resources associated with the channel bandwidth, wherein the second BWP pair comprises a second uplink BWP and a second downlink BWP, and wherein the second uplink BWP is decoupled from the second downlink BWP; e.g., as described in connection with 1706, 1710, and 1712 of FIG. 17.

The communication manager 1832 further includes a maintaining component 1844 configured to maintain the second BWP pair to communicate with the wireless node via non-SBFD resources of the channel bandwidth after the switch from the first BWP pair to the second BWP pair, e.g., as described in connection with 1714 of FIG. 17.

The apparatus may include additional components that perform each of the blocks of the algorithm in the aforementioned flowchart of FIG. 17. As such, each block in the aforementioned flowchart may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1802, and in particular the baseband unit 1804, includes: means for outputting, for transmission to the wireless node, an SBFD configuration indicative of one or more of: (i) an uplink subband and a downlink subband of the SBFD resources, and (ii) the second BWP pair and its association with the SBFD resources; means for outputting, for transmission to the wireless node, an indication of when communication with the wireless node via SBFD resources of the channel bandwidth begins, wherein the switch occurs after outputting the indication; means for obtaining an indication of a capability of the wireless node to communicate via a decoupled BWP pair; means for outputting, for transmission after obtaining the indication of the capability, an SBFD configuration indicative of one or more of: (i) an uplink subband and a downlink subband of the SBFD resources, and (ii) the second BWP pair and its association with the SBFD resources; means for communicating with a wireless node, said communication being via non-subband full-duplex (non-SBFD) resources associated with a channel bandwidth and via a first bandwidth part (BWP) pair; means for communicating with the wireless node by switching from the first BWP pair to a second BWP pair, said communication being via SBFD resources associated with the channel bandwidth, wherein the second BWP pair comprises a second uplink BWP and a second downlink BWP, and wherein the second uplink BWP is decoupled from the second downlink BWP; and means for maintaining the second BWP pair to communicate with the wireless node via non-SBFD resources of the channel bandwidth after the switch from the first BWP pair to the second BWP pair.

Means for receiving or means for obtaining may include a receiver (such as the receive processor 370) and/or an antenna(s) 320 of the network entity or base station 102 illustrated in FIG. 3). Means for transmitting or means for outputting may include a transmitter (such as the transmit processor 316 or antenna(s) 320 of the network entity or base station 102 illustrated in FIG. 3). Means for communicating may include the means for receiving/obtaining and the means for outputting/transmitting. Means for maintaining and means for switching (e.g., means for switching a BWP) may include a processing system, which may include one or more processors, such as the controller/processor 375, the memory 376, and/or any other suitable hardware components of the network entity or base station 102 illustrated in FIG. 3.

The aforementioned means may be one or more of the aforementioned components of the apparatus 1802 configured to perform the functions recited by the aforementioned means. As described supra, the apparatus 1802 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

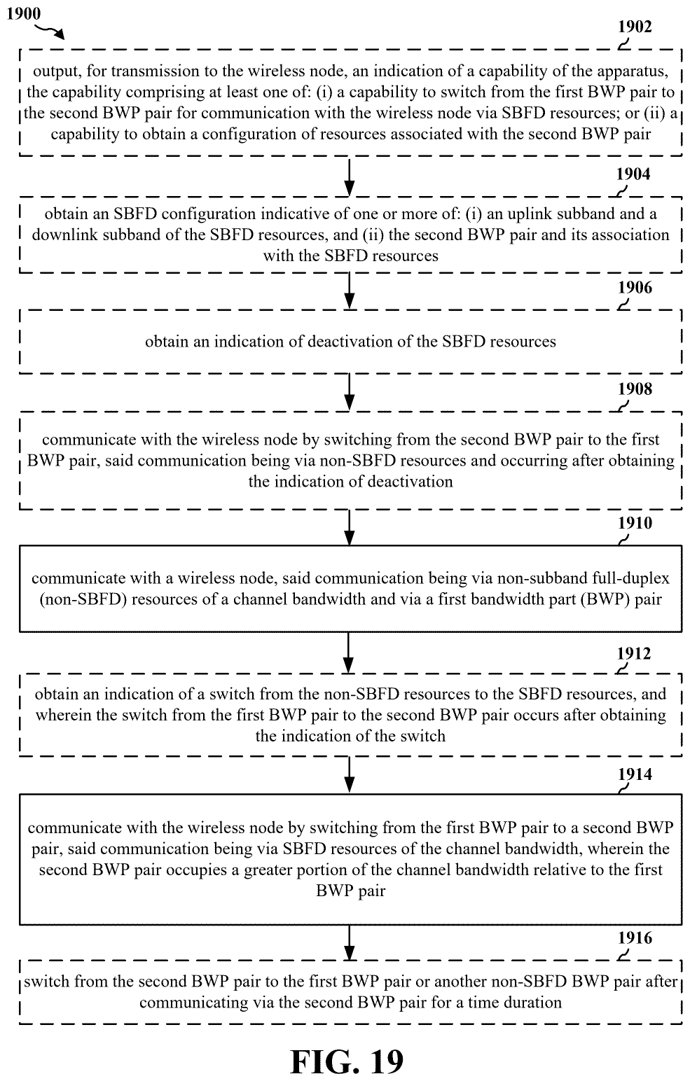

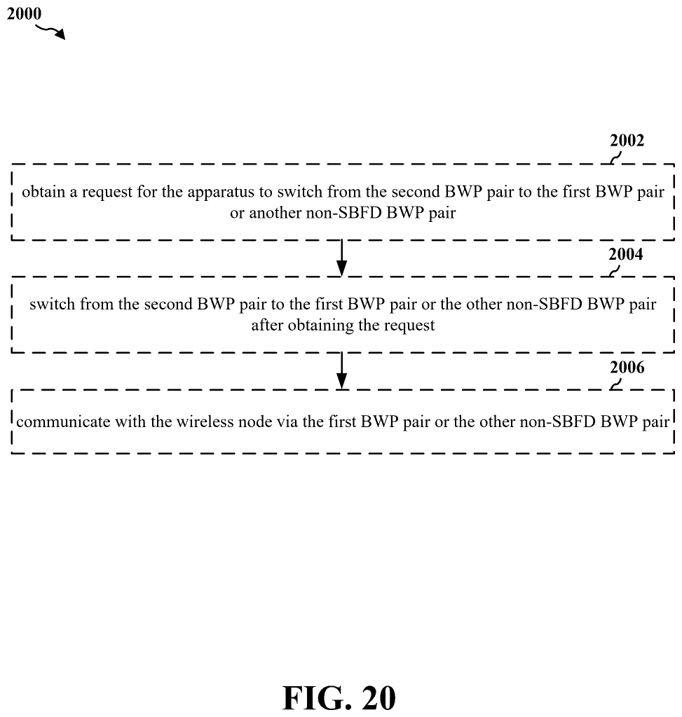

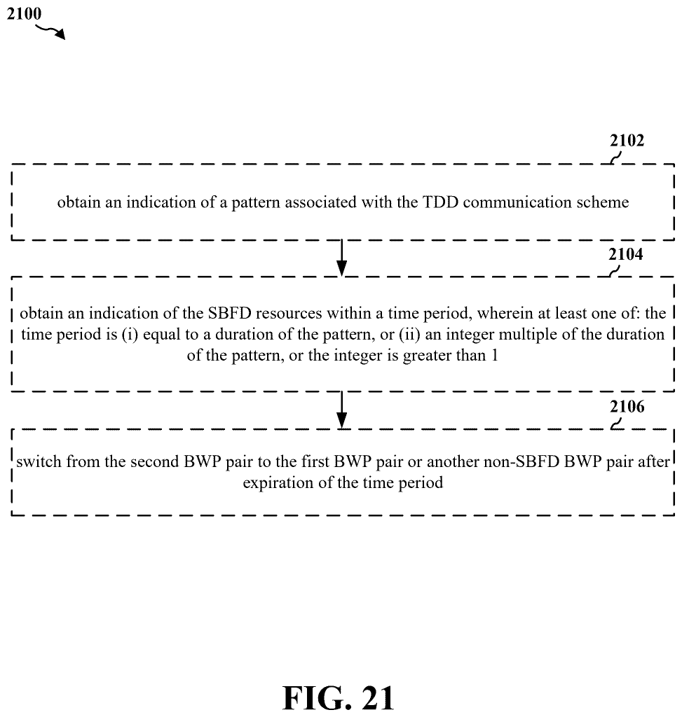

FIG. 19 is a flowchart 1900 of a method of wireless communication. The method may be performed by a UE (e.g., the UE 104; the apparatus 2202). One or more of the aspects of FIG. 19 may be performed in conjunction with one or more aspects of FIGS. 20 and 21. Specifically, the method may be performed by one or more memories, processors, and RF front ends (e.g., the memory 360, controller/processor 359, transmitter 354TX, receiver 354RX, antenna 352, etc., of FIG. 3).

At 1902, the UE may optionally output, for transmission to the wireless node, an indication of a capability of the apparatus, the capability comprising at least one of: (i) a capability to switch from the first BWP pair to the second BWP pair for communication with the wireless node via SBFD resources, or (ii) a capability to obtain a configuration of resources associated with the second BWP pair. For example, 1902 may be performed by an outputting component 2240.

At 1904, the UE may optionally obtain an SBFD configuration indicative of one or more of: (i) an uplink subband and a downlink subband of the SBFD resources, and (ii) the second BWP pair and its association with the SBFD resources. For example, 1904 may be performed by an obtaining component 2242.

At 1906, the UE may optionally obtain an indication of deactivation of the SBFD resources. For example, 1906 may be performed by the obtaining component 2242.

At 1908, the UE may optionally communicate with the wireless node by switching from the second BWP pair to the first BWP pair, said communication being via non-SBFD resources and occurring after obtaining the indication of deactivation. For example, 1908 may be performed by the outputting component 2240 and the obtaining component 2242.

At 1910, the UE may communicate with a wireless node, said communication being via non-subband full-duplex (non-SBFD) resources associated with a channel bandwidth and via a first bandwidth part (BWP) pair. For example, 1910 may be performed by the outputting component 2240 and the obtaining component 2242.

At 1912, the UE may optionally obtain an indication of a switch from the non-SBFD resources to the SBFD resources, and wherein the switch from the first BWP pair to the second BWP pair occurs after obtaining the indication of the switch. For example, 1912 may be performed by the obtaining component 2242.

At 1914, the UE may communicate with the wireless node by switching from the first BWP pair to a second BWP pair, said communication being via SBFD resources associated with the channel bandwidth, wherein the second BWP pair occupies a greater portion of the channel bandwidth relative to the first BWP pair. For example, 1914 may be performed by the outputting component 2240, the obtaining component 2242, and a switching component 2244.

At 1916, the UE may optionally switch from the second BWP pair to the first BWP pair or another non-SBFD BWP pair after communicating via the second BWP pair for a time duration. For example, 1916 may be performed by the switching component 2244. In some examples, the time duration may include any suitable duration of time (e.g., 5 ms).

In certain aspects, at least one of: the first BWP pair comprises a first uplink BWP and a first downlink BWP; the second BWP pair comprises a second uplink BWP and a second downlink BWP; or the second BWP pair is configured to provide at least one of: (i) a first ratio of usable downlink physical resource blocks (PRBs) in the second downlink BWP to total downlink PRBs in the second downlink BWP, or (ii) a second ratio of usable uplink PRBs in the second uplink BWP to total uplink PRBs in the second uplink BWP.

In certain aspects, the SBFD resources are associated with an uplink subband and a downlink subband; the usable downlink PRBs are resources of the downlink subband that overlap with resources of the second downlink BWP; and the usable uplink PRBs are resources of the uplink subband that overlap with resources of the second downlink BWP.

In certain aspects, at least one of: the second uplink BWP occupies a greater portion of the channel bandwidth than the first uplink BWP; or the second downlink BWP occupies a greater portion of the channel bandwidth than the first downlink BWP.

In certain aspects, at least one of: the SBFD configuration is further indicative of time locations associated with the SBFD resources; or the time locations are within a time-division duplex (TDD) pattern period.

In certain aspects, the indication of the second BWP pair comprises one of: (i) a configuration of resources associated with the second BWP pair or (ii) an identifier of the second BWP pair.

In certain aspects, at least one of: an uplink BWP of the second BWP pair occupies the entire channel bandwidth; or a downlink BWP of the second BWP pair occupies the entire channel bandwidth.

In certain aspects, the time duration is equal to a duration of communication with the wireless node via the SBFD resources.

In certain aspects, at least one of: the communication with the wireless node is via a time-division duplex (TDD) communication scheme; the non-SBFD resources are contained within a first slot; or the SBFD resources are contained within at least one of the first slot or a second slot.

FIG. 20 is a flowchart 2000 of a method of wireless communication. The method may be performed by a UE (e.g., the UE 104; the apparatus 2202). One or more of the aspects of FIG. 20 may be performed in conjunction with one or more aspects of FIGS. 19 and 21. Specifically, the method may be performed by one or more memories, processors, and RF front ends (e.g., the memory 360, controller/processor 359, transmitter 354TX, receiver 354RX, antenna 352, etc., of FIG. 3).

At 2002, the UE may optionally obtain a request for the apparatus to switch from the second BWP pair to the first BWP pair or another non-SBFD BWP pair. For example, 2002 may be performed by the obtaining component 2242.

At 2004, the UE may optionally switch from the second BWP pair to the first BWP pair or the other non-SBFD BWP pair after obtaining the request. For example, 2004 may be performed by the switching component 2244.

At 2006, the UE may optionally communicate with the wireless node via the first BWP pair or the other non-SBFD BWP pair. For example, 2006 may be performed by the outputting component 2240 and the obtaining component 2242.

FIG. 21 is a flowchart 2100 of a method of wireless communication. The method may be performed by a UE (e.g., the UE 104; the apparatus 2202). One or more of the aspects of FIG. 21 may be performed in conjunction with one or more aspects of FIGS. 19 and 20. Specifically, the method may be performed by one or more memories, processors, and RF front ends (e.g., the memory 360, controller/processor 359, transmitter 354TX, receiver 354RX, antenna 352, etc., of FIG. 3).

At 2102, the UE may optionally obtain an indication of a pattern associated with the TDD communication scheme. For example, 2102 may be performed by the obtaining component 2242.

At 2104, the UE may optionally obtain an indication of the SBFD resources within a time period, wherein at least one of: the time period is equal to a duration of the pattern, or is an integer multiple of the duration of the pattern, or the integer is greater than 1. For example, 2104 may be performed by the obtaining component 2242.

At 2106, the UE may optionally switch from the second BWP pair to the first BWP pair or another non-SBFD BWP pair after expiration of the time period. For example, 2106 may be performed by the switching component 2244.

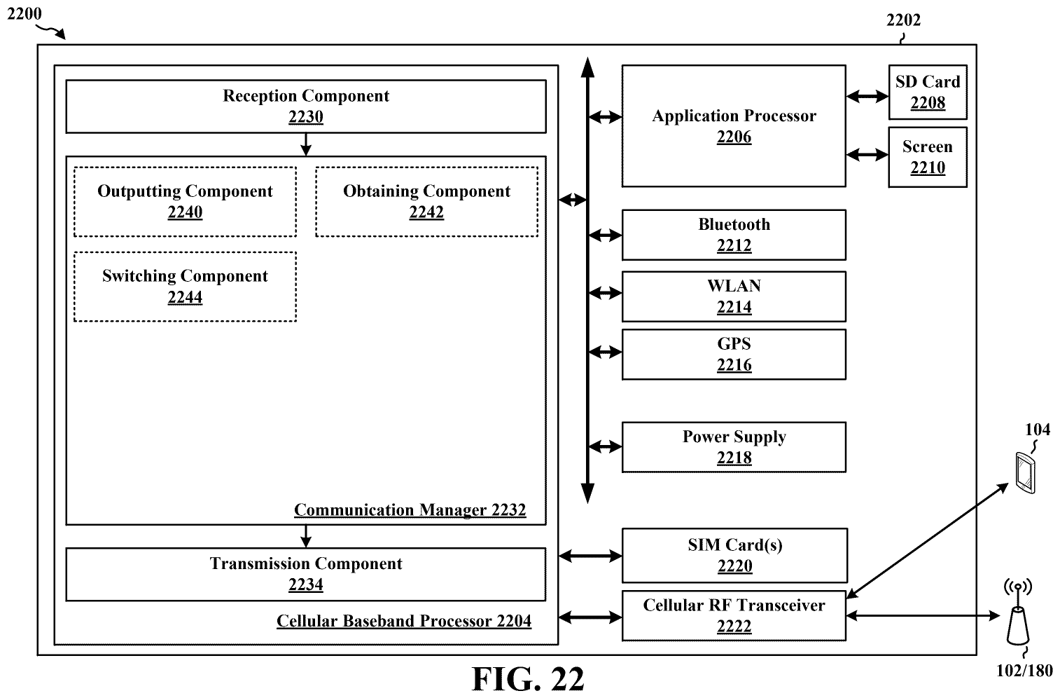

FIG. 22 is a diagram 2200 illustrating an example of a hardware implementation for an apparatus 2202. The apparatus 2202 is a UE and includes a cellular baseband processor 2204 (also referred to as a modem) coupled to a cellular RF transceiver 2222 and one or more subscriber identity modules (SIM) cards 2220, an application processor 2206 coupled to a secure digital (SD) card 2208 and a screen 2210, a Bluetooth module 2212, a wireless local area network (WLAN) module 2214, a Global Positioning System (GPS) module 2216, and a power supply 2218. The cellular baseband processor 2204 communicates through the cellular RF transceiver 2222 with the UE 104 and/or BS 102/180. The cellular baseband processor 2204 may include a computer-readable medium/memory. The computer-readable medium/memory may be non-transitory. The cellular baseband processor 2204 is responsible for general processing, including the execution of software stored on the computer-readable medium/memory. The software, when executed by the cellular baseband processor 2204, causes the cellular baseband processor 2204 to perform the various functions described supra. The computer-readable medium/memory may also be used for storing data that is manipulated by the cellular baseband processor 2204 when executing software. The cellular baseband processor 2204 further includes a reception component 2230, a communication manager 2232, and a transmission component 2234. The communication manager 2232 includes the one or more illustrated components. The components within the communication manager 2232 may be stored in the computer-readable medium/memory and/or configured as hardware within the cellular baseband processor 2204. The cellular baseband processor 2204 may be a component of the UE 104 and may include the memory 360 and/or at least one of the TX processor 368, the RX processor 356, and the controller/processor 359. In one configuration, the apparatus 2202 may be a modem chip and include just the baseband processor 2204, and in another configuration, the apparatus 2202 may be the entire UE (e.g., see UE 104 of FIG. 3) and include the aforediscussed additional modules of the apparatus 2202. In various examples, the apparatus 2202 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

The communication manager 2232 includes an outputting component 2240 that is configured to: output, for transmission to the wireless node, an indication of a capability of the apparatus, the capability comprising at least one of: (i) a capability to switch from the first BWP pair to the second BWP pair for communication with the wireless node via SBFD resources, or (ii) a capability to obtain a configuration of resources associated with the second BWP pair; communicate with the wireless node by switching from the second BWP pair to the first BWP pair, said communication being via non-SBFD resources and occurring after obtaining the indication of deactivation; communicate with a wireless node, said communication being via non-subband full-duplex (non-SBFD) resources associated with a channel bandwidth and via a first bandwidth part (BWP) pair; communicate with the wireless node by switching from the first BWP pair to a second BWP pair, said communication being via SBFD resources associated with the channel bandwidth, wherein the second BWP pair occupies a greater portion of the channel bandwidth relative to the first BWP pair; communicate with the wireless node via the first BWP pair or the other non-SBFD BWP pair; e.g., as described in connection with 1902, 1908, 1910, and 1914 of FIGS. 19, and 2006 of FIG. 20.

The communication manager 2232 further includes an obtaining component 2242 configured to obtain an SBFD configuration indicative of one or more of: (i) an uplink subband and a downlink subband of the SBFD resources, and (ii) the second BWP pair and its association with the SBFD resources; obtain an indication of deactivation of the SBFD resources; communicate with the wireless node by switching from the second BWP pair to the first BWP pair, said communication being via non-SBFD resources and occurring after obtaining the indication of deactivation; communicate with a wireless node, said communication being via non-subband full-duplex (non-SBFD) resources associated with a channel bandwidth and via a first bandwidth part (BWP) pair; obtain an indication of a switch from the non-SBFD resources to the SBFD resources, and wherein the switch from the first BWP pair to the second BWP pair occurs after obtaining the indication of the switch; communicate with the wireless node by switching from the first BWP pair to a second BWP pair, said communication being via SBFD resources associated with the channel bandwidth, wherein the second BWP pair occupies a greater portion of the channel bandwidth relative to the first BWP pair; obtain a request for the apparatus to switch from the second BWP pair to the first BWP pair or another non-SBFD BWP pair; communicate with the wireless node via the first BWP pair or the other non-SBFD BWP pair; obtain an indication of a pattern associated with the TDD communication scheme; and obtain an indication of the SBFD resources within a time period, wherein at least one of: the time period is equal to a duration of the pattern, or is an integer multiple of the duration of the pattern, or the integer is greater than 1; e.g., as described in connection with 1904, 1906, 1908, 1910, 1912, and 1914 of FIGS. 19, 2002 and 2006 of FIGS. 20, and 2102 and 2104 of FIG. 21.

The communication manager 2232 further includes a switching component 2244 configured to switch from the second BWP pair to the first BWP pair or another non-SBFD BWP pair after communicating via the second BWP pair for a time duration; switch from the second BWP pair to the first BWP pair or the other non-SBFD BWP pair after obtaining the request; and switch from the second BWP pair to the first BWP pair or another non-SBFD BWP pair after expiration of the time period; e.g., as described in connection with 1916 of FIG. 19, 2004 of FIGS. 20, and 2106 of FIG. 21.

The apparatus may include additional components that perform each of the blocks of the algorithm in the aforementioned flowcharts of FIGS. 19-21. As such, each block in the aforementioned flowcharts may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 2202, and in particular the cellular baseband processor 2204, includes: means for outputting, for transmission to the wireless node, an indication of a capability of the apparatus, the capability comprising at least one of: (i) a capability to switch from the first BWP pair to the second BWP pair for communication with the wireless node via SBFD resources, or (ii) a capability to obtain a configuration of resources associated with the second BWP pair; means for obtaining an SBFD configuration indicative of one or more of: (i) an uplink subband and a downlink subband of the SBFD resources, and (ii) the second BWP pair and its association with the SBFD resources; means for obtaining an indication of deactivation of the SBFD resources; means for communicating with the wireless node by switching from the second BWP pair to the first BWP pair, said communication being via non-SBFD resources and occurring after obtaining the indication of deactivation; means for communicating with a wireless node, said communication being via non-subband full-duplex (non-SBFD) resources associated with a channel bandwidth and via a first bandwidth part (BWP) pair; means for obtaining an indication of a switch from the non-SBFD resources to the SBFD resources, and wherein the switch from the first BWP pair to the second BWP pair occurs after obtaining the indication of the switch; means for communicating with the wireless node by switching from the first BWP pair to a second BWP pair, said communication being via SBFD resources associated with the channel bandwidth, wherein the second BWP pair occupies a greater portion of the channel bandwidth relative to the first BWP pair; means for switching from the second BWP pair to the first BWP pair or another non-SBFD BWP pair after communicating via the second BWP pair for a time duration; means for obtaining a request for the apparatus to switch from the second BWP pair to the first BWP pair or another non-SBFD BWP pair; means for switching from the second BWP pair to the first BWP pair or the other non-SBFD BWP pair after obtaining the request; means for communicating with the wireless node via the first BWP pair or the other non-SBFD BWP pair; means for obtaining an indication of a pattern associated with the TDD communication scheme; means for obtaining an indication of the SBFD resources within a time period, wherein at least one of: the time period is equal to a duration of the pattern, or is an integer multiple of the duration of the pattern, or the integer is greater than 1; and means for switching from the second BWP pair to the first BWP pair or another non-SBFD BWP pair after expiration of the time period.

The aforementioned means may be one or more of the aforementioned components of the apparatus 2202 configured to perform the functions recited by the aforementioned means. As described supra, the apparatus 2202 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

Means for receiving or means for obtaining may include a receiver such as the receive processor 356 and/or antenna(s) 352 of the UE 104 illustrated in FIG. 3. Means for transmitting or means for outputting may include a transmitter such as the transmit processor 368 or antenna(s) 352 of the UE 104 illustrated in FIG. 3. Means for communicating may include the means for receiving/obtaining and the means for transmitting/outputting. Means for switching may include a processing system, which may include one or more processors, such as the controller/processor 359, the memory 360, and/or any other suitable hardware components of the UE 104 illustrated in FIG. 3.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

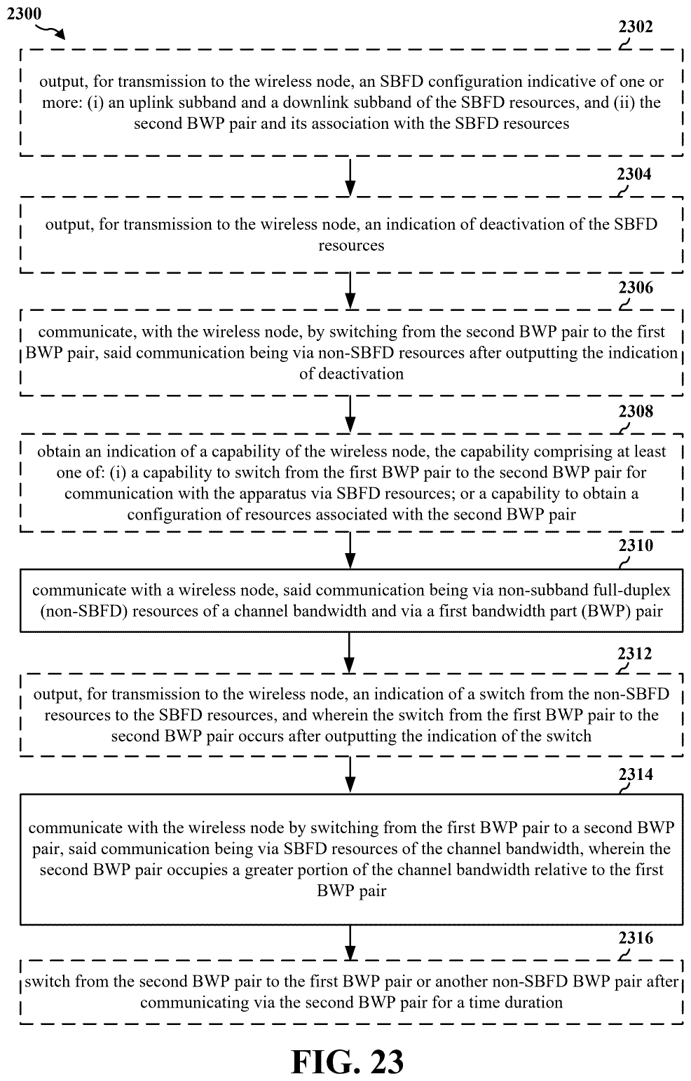

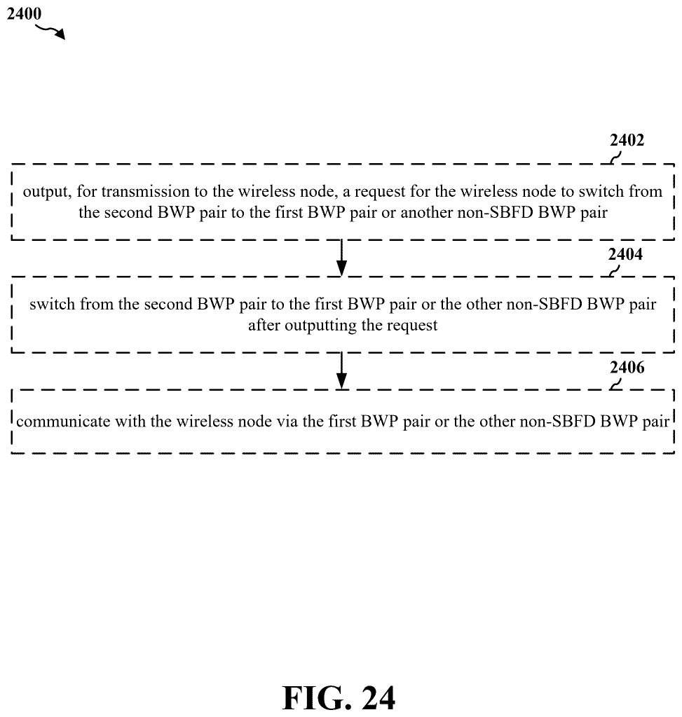

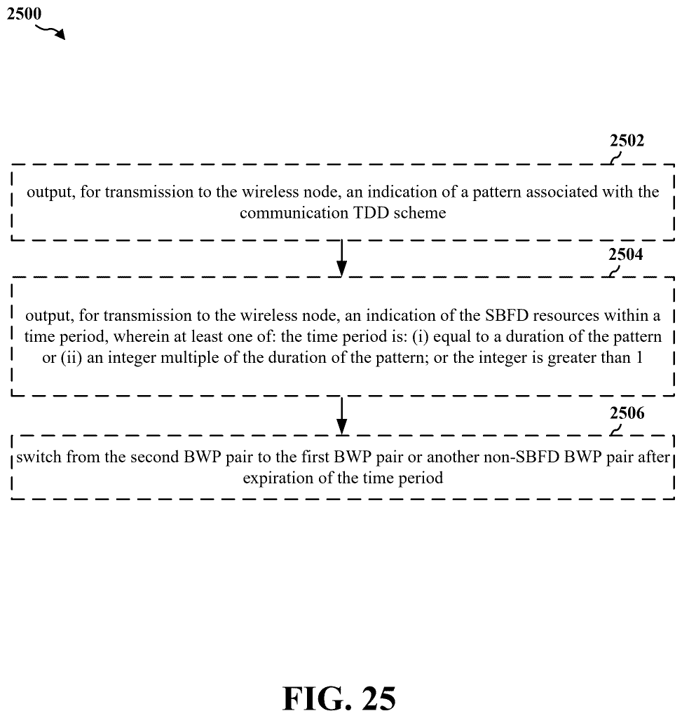

FIG. 23 is a flowchart 2300 of a method of wireless communication. The method may be performed by a network entity or base station (e.g., the base station 102/180; the apparatus 2602). One or more of the aspects of FIG. 23 may be performed in conjunction with one or more aspects of FIGS. 24 and 25. Specifically, the method may be performed by one or more memories, processors, and RF front ends (e.g., the memory 376, controller/processor 375, transmitter 318TX, receiver 318RX, antenna 320, etc. of FIG. 3).

At 2302, the network entity may optionally output, for transmission to the wireless node, an SBFD configuration indicative of one or more: (i) an uplink subband and a downlink subband of the SBFD resources, and (ii) the second BWP pair and its association with the SBFD resources. For example, 2302 may be performed by an outputting component 2640.

At 2304, the network entity may optionally output, for transmission to the wireless node, an indication of deactivation of the SBFD resources. For example, 2304 may be performed by the outputting component 2640.

At 2306, the network entity may optionally communicate, with the wireless node, by switching from the second BWP pair to the first BWP pair, said communication being via non-SBFD resources after outputting the indication of deactivation. For example, 2306 may be performed by a switching component 2642.

At 2308, the network entity may optionally obtain an indication of a capability of the wireless node, the capability comprising at least one of: (i) a capability to switch from the first BWP pair to the second BWP pair for communication with the network entity via SBFD resources; or a capability to obtain a configuration of resources associated with the second BWP pair. For example, 2306 may be performed by an obtaining component 2644.

At 2310, the network entity may communicate with a wireless node, said communication being via non-subband full-duplex (non-SBFD) resources associated with a channel bandwidth and via a first bandwidth part (BWP) pair. For example, 2306 may be performed by the outputting component 2640 and the obtaining component 2644.

At 2312, the network entity may optionally output, for transmission to the wireless node, an indication of a switch from the non-SBFD resources to the SBFD resources, and wherein the switch from the first BWP pair to the second BWP pair occurs after outputting the indication of the switch. For example, 2312 may be performed by the outputting component 2640.

At 2314, the network entity may communicate with the wireless node by switching from the first BWP pair to a second BWP pair, said communication being via SBFD resources associated with the channel bandwidth, wherein the second BWP pair occupies a greater portion of the channel bandwidth relative to the first BWP pair. For example, 2314 may be performed by the outputting component 2640 and the obtaining component 2644.

At 2316, the network entity may optionally switch from the second BWP pair to the first BWP pair or another non-SBFD BWP pair after communicating via the second BWP pair for a time duration. For example, 2316 may be performed by the switching component 2642.

In certain aspects, at least one of: the first BWP pair comprises a first uplink BWP and a first downlink BWP; the second BWP pair comprises a second uplink BWP and a second downlink BWP; or the second BWP pair is configured to provide at least one of: (i) a first ratio of usable downlink physical resource blocks (PRBs) in the second downlink BWP to total downlink PRBs in the second downlink BWP, or (ii) a second ratio of usable uplink PRBs in the second uplink BWP to total uplink PRBs in the second uplink BWP.

In certain aspects, the SBFD resources are associated with an uplink subband and a downlink subband; the usable downlink PRBs are resources of the downlink subband that overlap with resources of the second downlink BWP; and the usable uplink PRBs are resources of the uplink subband that overlap with resources of the second downlink BWP.

In certain aspects, at least one of: the second uplink BWP occupies a greater portion of the channel bandwidth than the first uplink BWP; or the second downlink BWP occupies a greater portion of the channel bandwidth than the first downlink BWP.

In certain aspects, at least one of: the SBFD configuration is further indicative of time locations associated with the SBFD resources; or the time locations are within a time-division duplex (TDD) pattern period.

In certain aspects, the indication of the second BWP pair comprises one of: (i) a configuration of resources associated with the second BWP pair or (ii) an identifier of the second BWP pair.

In certain aspects, the time duration is equal to a duration of communication with the wireless node via the SBFD resources.

In certain aspects, at least one of: the communication with the wireless node is via a time-division duplex (TDD) communication scheme; the non-SBFD resources are contained within a first slot; or the SBFD resources are contained within at least one of the first slot or a second slot.

In certain aspects, at least one of: an uplink BWP of the second BWP pair occupies the entire channel bandwidth; or a downlink BWP of the second BWP pair occupies the entire channel bandwidth.

FIG. 24 is a flowchart 2400 of a method of wireless communication. The method may be performed by a network entity or base station (e.g., the base station 102/180; the apparatus 2602). One or more of the aspects of FIG. 24 may be performed in conjunction with one or more aspects of FIGS. 23 and 25. Specifically, the method may be performed by one or more memories, processors, and RF front ends (e.g., the memory 376, controller/processor 375, transmitter 318TX, receiver 318RX, antenna 320, etc. of FIG. 3).

At 2402, the network entity may optionally output, for transmission to the wireless node, a request for the wireless node to switch from the second BWP pair to the first BWP pair or another non-SBFD BWP pair. For example, 2402 may be performed by the outputting component 2640.

At 2404, the network entity may optionally switch from the second BWP pair to the first BWP pair or the other non-SBFD BWP pair after outputting the request. For example, 2404 may be performed by the switching component 2642.

At 2406, the network entity may optionally communicate with the wireless node via the first BWP pair or the other non-SBFD BWP pair. For example, 2406 may be performed by the outputting component 2640 and the obtaining component 2644.

FIG. 25 is a flowchart 2500 of a method of wireless communication. The method may be performed by a network entity or base station (e.g., the base station 102/180; the apparatus 2602). One or more of the aspects of FIG. 25 may be performed in conjunction with one or more aspects of FIGS. 23 and 24. Specifically, the method may be performed by one or more memories, processors, and RF front ends (e.g., the memory 376, controller/processor 375, transmitter 318TX, receiver 318RX, antenna 320, etc. of FIG. 3).

At 2502, the network entity may optionally output, for transmission to the wireless node, an indication of a pattern associated with the communication TDD scheme. For example, 2502 may be performed by the outputting component 2640.

At 2504, the network entity may optionally output, for transmission to the wireless node, an indication of the SBFD resources within a time period, wherein at least one of: the time period is: (i) equal to a duration of the pattern or (ii) an integer multiple of the duration of the pattern; or the integer is greater than 1. For example, 2504 may be performed by the outputting component 2640.

At 2506, the network entity may optionally switch from the second BWP pair to the first BWP pair or another non-SBFD BWP pair after expiration of the time period. For example, 2406 may be performed by the switching component 2642.

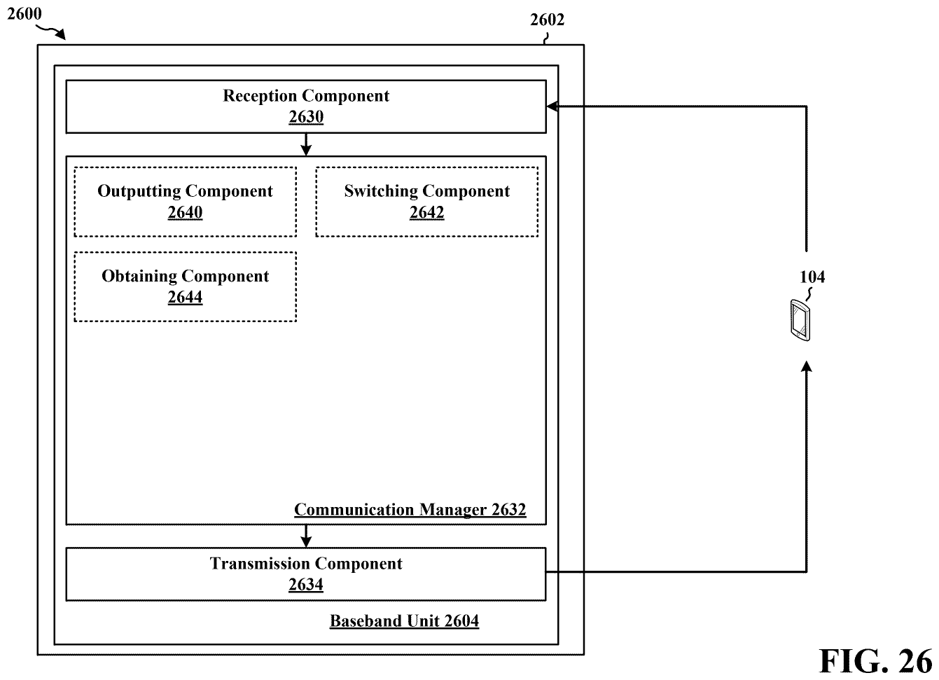

FIG. 26 is a diagram 2600 illustrating an example of a hardware implementation for an apparatus 2602. The apparatus 2602 is a BS and includes a baseband unit 2604. The baseband unit 2604 may communicate through a cellular RF transceiver with the UE 104. The baseband unit 2604 may include a computer-readable medium/memory. The baseband unit 2604 is responsible for general processing, including the execution of software stored on the computer-readable medium/memory. The software, when executed by the baseband unit 2604, causes the baseband unit 2604 to perform the various functions described supra. The computer-readable medium/memory may also be used for storing data that is manipulated by the baseband unit 2604 when executing software. The baseband unit 2604 further includes a reception component 2630, a communication manager 2632, and a transmission component 2634. The communication manager 2632 includes the one or more illustrated components. The components within the communication manager 2632 may be stored in the computer-readable medium/memory and/or configured as hardware within the baseband unit 2604. The baseband unit 2604 may be a component of the BS 102/180 and may include the memory 376 and/or at least one of the TX processor 316, the RX processor 370, and the controller/processor 375. In various examples, the apparatus 2602 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

The communication manager 2632 includes an outputting component 2640 configured to: output, for transmission to the wireless node, an SBFD configuration indicative of one or more: (i) an uplink subband and a downlink subband of the SBFD resources, and (ii) the second BWP pair and its association with the SBFD resources; output, for transmission to the wireless node, an indication of deactivation of the SBFD resources; output, for transmission to the wireless node, an indication of a switch from the non-SBFD resources to the SBFD resources, and wherein the switch from the first BWP pair to the second BWP pair occurs after outputting the indication of the switch; communicate with a wireless node, said communication being via non-subband full-duplex (non-SBFD) resources associated with a channel bandwidth and via a first bandwidth part (BWP) pair; communicate with the wireless node by switching from the first BWP pair to a second BWP pair, said communication being via SBFD resources associated with the channel bandwidth, wherein the second BWP pair occupies a greater portion of the channel bandwidth relative to the first BWP pair; output, for transmission to the wireless node, a request for the wireless node to switch from the second BWP pair to the first BWP pair or another non-SBFD BWP pair; communicate with the wireless node via the first BWP pair or the other non-SBFD BWP pair; output, for transmission to the wireless node, an indication of a pattern associated with the communication TDD scheme; and output, for transmission to the wireless node, an indication of the SBFD resources within a time period, wherein at least one of: the time period is: (i) equal to a duration of the pattern or (ii) an integer multiple of the duration of the pattern; or the integer is greater than 1; e.g., as described in connection with 2302, 2304, 2310, 2312, and 2314 of FIGS. 23, 2402 and 2406 of FIGS. 24, and 2502 and 2504 of FIG. 25.

The communication manager 2632 further includes a switching component 2642 configured to: communicate, with the wireless node, by switching from the second BWP pair to the first BWP pair, said communication being via non-SBFD resources after outputting the indication of deactivation; switch from the second BWP pair to the first BWP pair or another non-SBFD BWP pair after communicating via the second BWP pair for a time duration; switch from the second BWP pair to the first BWP pair or the other non-SBFD BWP pair after outputting the request; and switch from the second BWP pair to the first BWP pair or another non-SBFD BWP pair after expiration of the time period; e.g., as described in connection with 2306 and 2316 of FIG. 23, 2404 of FIGS. 24, and 2506 of FIG. 25.

The communication manager 2632 further includes an obtaining component 2644 configured to: obtain an indication of a capability of the wireless node, the capability comprising at least one of: (i) a capability to switch from the first BWP pair to the second BWP pair for communication with the apparatus 2602 via SBFD resources; or a capability to obtain a configuration of resources associated with the second BWP pair; e.g., as described in connection with FIG. 23.

The apparatus may include additional components that perform each of the blocks of the algorithm in the aforementioned flowcharts of FIGS. 23-25. As such, each block in the aforementioned flowcharts may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 2602, and in particular the baseband unit 2604, includes: means for communicating with a wireless node, said communication being via non-subband full-duplex (non-SBFD) resources associated with a channel bandwidth and via a first bandwidth part (BWP) pair; means for communicating with the wireless node by switching from the first BWP pair to a second BWP pair, said communication being via SBFD resources associated with the channel bandwidth, wherein the second BWP pair occupies a greater portion of the channel bandwidth relative to the first BWP pair; means for outputting, for transmission to the wireless node, an SBFD configuration indicative of one or more: (i) an uplink subband and a downlink subband of the SBFD resources, and (ii) the second BWP pair and its association with the SBFD resources; means for outputting, for transmission to the wireless node, an indication of a switch from the non-SBFD resources to the SBFD resources, and wherein the switch from the first BWP pair to the second BWP pair occurs after outputting the indication of the switch; means for outputting, for transmission to the wireless node, an indication of deactivation of the SBFD resources; means for communicating, with the wireless node, by switching from the second BWP pair to the first BWP pair, said communication being via non-SBFD resources after outputting the indication of deactivation; means for obtaining an indication of a capability of the wireless node, the capability comprising at least one of: (i) a capability to switch from the first BWP pair to the second BWP pair for communication with the apparatus 2602 via SBFD resources; or a capability to obtain a configuration of resources associated with the second BWP pair; means for outputting, for transmission to the wireless node, a request for the wireless node to switch from the second BWP pair to the first BWP pair or another non-SBFD BWP pair; means for switching from the second BWP pair to the first BWP pair or the other non-SBFD BWP pair after outputting the request; means for communicating with the wireless node via the first BWP pair or the other non-SBFD BWP pair; means for switching from the second BWP pair to the first BWP pair or another non-SBFD BWP pair after communicating via the second BWP pair for a time duration; means for outputting, for transmission to the wireless node, an indication of a pattern associated with the communication TDD scheme; means for outputting, for transmission to the wireless node, an indication of the SBFD resources within a time period, wherein at least one of: the time period is: (i) equal to a duration of the pattern or (ii) an integer multiple of the duration of the pattern; or the integer is greater than 1; means for switching from the second BWP pair to the first BWP pair or another non-SBFD BWP pair after expiration of the time period.

The aforementioned means may be one or more of the aforementioned components of the apparatus 2602 configured to perform the functions recited by the aforementioned means. As described supra, the apparatus 2602 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

Means for receiving or means for obtaining may include a receiver such as the receive processor 370 and/or antenna(s) 320 of the network entity or base station 102 illustrated in FIG. 3. Means for transmitting or means for outputting may include a transmitter such as the transmit processor 316 or antenna(s) 320 of the network entity or base station 102 illustrated in FIG. 3. Means for communicating may include the means for receiving/obtaining and the means for transmitting/outputting. Means for switching may include a processing system, which may include one or more processors, such as the controller/processor 375, the memory 376, and/or any other suitable hardware components of the network entity or base station 102 illustrated in FIG. 3.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

### ADDITIONAL CONSIDERATIONS

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

### Example Aspects

The following examples are illustrative only and may be combined with aspects of other embodiments or teachings described herein, without limitation.

Example 1 is a method for wireless communication at a first wireless node, comprising: communicating with a second wireless node, said communication being via non-subband full-duplex (non-SBFD) resources associated with a channel bandwidth and via a first bandwidth part (BWP) pair; and communicating with the second wireless node by switching from the first BWP pair to a second BWP pair, said communication being via SBFD resources associated with the channel bandwidth, wherein the second BWP pair comprises a second uplink BWP and a second downlink BWP, and wherein the second uplink BWP is decoupled from the second downlink BWP.

Example 2 is the method of Example 1, wherein the method further comprises: maintaining the second BWP pair to communicate with the second wireless node via non-SBFD resources of the channel bandwidth after the switch from the first BWP pair to the second BWP pair.

Example 3 is the method of any of Examples 1 and 2, wherein: the second uplink BWP comprises less than or equal to X physical resource blocks (PRBs); and the second downlink BWP comprises less than or equal to Y PRBs.

Example 4 is the method of Example 3, wherein: the SBFD resources comprise a downlink subband and an uplink subband; X is equal to a first number of PRBs within the uplink subband; and Y is equal to a second number of PRBs within the downlink subband.

Example 5 is the method of any of Examples 1-4, wherein the method further comprises: outputting, for transmission to the second wireless node, an indication of a capability of the first wireless node to communicate via a decoupled BWP pair; and obtaining, after outputting the indication of the capability, an SBFD configuration indicative of one or more of: (i) an uplink subband and a downlink subband of the SBFD resources, and (ii) the second BWP pair and its association with the SBFD resources.

Example 6 is the method of Example 5, wherein the SBFD configuration is further indicative of at least one of: the second uplink BWP being contained within the uplink subband; or the second downlink BWP being contained within the downlink subband.

Example 7 is the method of any of Examples 5 and 6, wherein at least one of: the second downlink BWP satisfies a first ratio of usable downlink physical resource blocks (PRBs) in the second downlink BWP to total downlink PRBs in the second downlink BWP; or the second uplink BWP satisfies a second ratio of usable uplink PRBs in the second uplink BWP to total uplink PRBs in the second uplink BWP.

Example 8 is the method of Example 7, wherein: the usable downlink PRBs are resources of the second downlink BWP that overlap with resources of the downlink subband; and the usable uplink PRBs are resources of the second downlink BWP that overlap with resources of the uplink subband.

Example 9 is the method of any of Examples 1-8, wherein the method further comprises: obtaining, from the second wireless node, an indication of when communication with the second wireless node via SBFD resources of the channel bandwidth begins, wherein the switch occurs after obtaining the indication.

Example 10 is the method of any of Examples 1-9, wherein the method further comprises: obtaining, from the second wireless node, an SBFD configuration indicative of one or more of: (i) an uplink subband and a downlink subband of the SBFD resources, and (ii) the second BWP pair and its association with the SBFD resources.

Example 11 is the method of Example 10, wherein the indication of the second BWP pair comprises at least one of: a first offset value indicating a first starting frequency of the second uplink BWP relative to a starting frequency of the channel bandwidth; or a second offset value indicating a second starting frequency of the second downlink BWP relative to the starting frequency of the channel bandwidth.

Example 12 is the method of Example 11, wherein: the first the BWP pair comprises a first uplink BWP coupled to a first downlink BWP; the first offset value is different from a third offset value indicating a third starting frequency of the first uplink BWP; and the second offset value is different from a fourth offset value indicating a fourth starting frequency of the first downlink BWP.

Example 13 is the method of any of Examples 1-12, wherein the first the BWP pair comprises a first uplink BWP coupled to a first downlink BWP, and wherein at least one of: the first uplink BWP is associated with a first center frequency different from a second center frequency associated with the second uplink BWP; or the first downlink BWP is associated with a third center frequency different from a fourth center frequency associated with the second downlink BWP.

Example 14 is the method of any of Examples 1-13, wherein the first the BWP pair comprises a first uplink BWP coupled to a first downlink BWP, and wherein at least one of: the first uplink BWP and the second uplink BWP both occupy a first number of physical resource blocks (PRBs); or the first downlink BWP and the second downlink BWP both occupy a second number of PRBs.

Example 15 is the method of any of Examples 1-14, wherein the first the BWP pair comprises a first uplink BWP coupled to a first downlink BWP, and wherein at least one of: the second uplink BWP comprises the first uplink BWP with expanded bandwidth; or the second downlink BWP comprises the first downlink BWP with expanded bandwidth.

Example 16 is an method for wireless communication at a first wireless node, comprising: communicating with a second wireless node, said communication being via non-subband full-duplex (non-SBFD) resources associated with a channel bandwidth and via a first bandwidth part (BWP) pair; and communicating with the second wireless node by switching from the first BWP pair to a second BWP pair, said communication being via SBFD resources associated with the channel bandwidth, wherein the second BWP pair comprises a second uplink BWP and a second downlink BWP, and wherein the second uplink BWP is decoupled from the second downlink BWP.

Example 17 is the method of Example 16, wherein the method further comprises: maintaining the second BWP pair to communicate with the second wireless node via non-SBFD resources of the channel bandwidth after the switch from the first BWP pair to the second BWP pair.

Example 18 is the method of any of Example 16 and 17, wherein: the second uplink BWP comprises less than or equal to X physical resource blocks (PRBs); and the second downlink BWP comprises less than or equal to Y PRBs.

Example 19 is the method of Example 18, wherein: the SBFD resources comprise a downlink subband and an uplink subband; X is equal to a first number of PRBs within the uplink subband; and Y is equal to a second number of PRBs within the downlink subband.

Example 20 is the method of any of Examples 16-19, wherein the method further comprises: obtaining an indication of a capability of the second wireless node to communicate via a decoupled BWP pair; and outputting, for transmission after obtaining the indication of the capability, an SBFD configuration indicative of one or more of: (i) an uplink subband and a downlink subband of the SBFD resources, and (ii) the second BWP pair and its association with the SBFD resources.

Example 21 is the method of Example 20, wherein the SBFD configuration is further indicative of at least one of: the second uplink BWP being contained within the uplink subband; or the second downlink BWP being contained within the downlink subband.

Example 22 is the method of any of Examples 20 and 21, wherein at least one of: the second downlink BWP satisfies a first ratio of usable downlink physical resource blocks (PRBs) in the second downlink BWP to total downlink PRBs in the second downlink BWP; or the second uplink BWP satisfies a second ratio of usable uplink PRBs in the second uplink BWP to total uplink PRBs in the second uplink BWP.

Example 23 is the method of Example 22, wherein: the usable downlink PRBs are resources of the second downlink BWP that overlap with resources of the downlink subband; and the usable uplink PRBs are resources of the second downlink BWP that overlap with resources of the uplink subband.

Example 24 is the method of any of Examples 16-23, wherein the method further comprises: outputting, for transmission to the second wireless node, an indication of when communication with the second wireless node via SBFD resources of the channel bandwidth begins, wherein the switch occurs after outputting the indication.

Example 25 is the method of any of Examples 16-24, wherein the method further comprises: outputting, for transmission to the second wireless node, an SBFD configuration indicative of one or more of: (i) an uplink subband and a downlink subband of the SBFD resources, and (ii) the second BWP pair and its association with the SBFD resources.

Example 26 is the method of Example 25, wherein the indication of the second BWP pair comprises at least one of: a first offset value indicating a first starting frequency of the second uplink BWP relative to a starting frequency of the channel bandwidth; or a second offset value indicating a second starting frequency of the second downlink BWP relative to the starting frequency of the channel bandwidth.

Example 27 is the method of Example 26, wherein: the first the BWP pair comprises a first uplink BWP coupled to a first downlink BWP; the first offset value is different from a third offset value indicating a third starting frequency of the first uplink BWP; and the second offset value is different from a fourth offset value indicating a fourth starting frequency of the first downlink BWP.

Example 28 is the method of any of Examples 16-27, wherein the first the BWP pair comprises a first uplink BWP coupled to a first downlink BWP, and wherein at least one of: the first uplink BWP is associated with a first center frequency different from a second center frequency associated with the second uplink BWP; or the first downlink BWP is associated with a third center frequency different from a fourth center frequency associated with the second downlink BWP.

Example 29 is the method of any of Examples 16-28, wherein the first the BWP pair comprises a first uplink BWP coupled to a first downlink BWP, and wherein at least one of: the first uplink BWP and the second uplink BWP both occupy a first number of physical resource blocks (PRBs); or the first downlink BWP and the second downlink BWP both occupy a second number of PRBs.

Example 30 is the method of any of Examples 16-29, wherein the first the BWP pair comprises a first uplink BWP coupled to a first downlink BWP, and wherein at least one of: the second uplink BWP comprises the first uplink BWP with expanded bandwidth; or the second downlink BWP comprises the first downlink BWP with expanded bandwidth.

Example 31 is an apparatus for wireless communications, comprising means for performing a method in accordance with any one of examples 1-15.

Example 32 is an apparatus for wireless communications, comprising means for performing a method in accordance with any one of examples 16-30.

Example 33 is a non-transitory computer-readable medium comprising instructions that, when executed by a wireless node, cause the wireless node to perform a method in accordance with any one of examples 1-15.

Example 34 is a non-transitory computer-readable medium comprising instructions that, when executed by a wireless node, cause the wireless node to perform a method in accordance with any one of examples 16-30.

Example 35 is an apparatus for wireless communications, comprising: one or more memories, individually or in combination, having instructions; and one or more processors, individually or in combination, configured to execute the instructions and cause the apparatus to perform a method in accordance with any one of examples 1-15.

Example 36 is an apparatus for wireless communications, comprising: one or more memories, individually or in combination, having instructions; and one or more processors, individually or in combination, configured to execute the instructions and cause the apparatus to perform a method in accordance with any one of examples 16-30.

Example 37 is a wireless node (e.g., UE), comprising: one or more transceivers via which communication with the wireless node occurs; one or more memories, individually or in combination, having instructions; and one or more processors, individually or in combination, configured to execute the instructions and cause the wireless node to perform a method in accordance with any one of examples 1-15, wherein the one or more transceivers are configured to: communicate with the second wireless node via non-SBFD resources; and communicate with the second wireless node by switching from the first BWP pair to the second BWP pair.

Example 38 is a wireless node (e.g., network entity), comprising: one or more transceivers via which communication with the wireless node occurs; one or more memories, individually or in combination, having instructions; and one or more processors, individually or in combination, configured to execute the instructions and cause the wireless node to perform a method in accordance with any one of examples 16-30, wherein the one or more transceivers are configured to: communicate with the second wireless node via non-SBFD resources; and communicate with the second wireless node by switching from the first BWP pair to the second BWP pair.

Example 39 is a method for wireless communication at a first wireless node, comprising: communicating with a second wireless node, said communication being via non-subband full-duplex (non-SBFD) resources associated with a channel bandwidth and via a first bandwidth part (BWP) pair; and communicating with the second wireless node by switching from the first BWP pair to a second BWP pair, said communication being via SBFD resources associated with the channel bandwidth, wherein the second BWP pair occupies a greater portion of the channel bandwidth relative to the first BWP pair.

Example 40 is the method of Example 39, wherein at least one of: the first BWP pair comprises a first uplink BWP and a first downlink BWP; the second BWP pair comprises a second uplink BWP and a second downlink BWP; or the second BWP pair is configured to provide at least one of: (i) a first ratio of usable downlink physical resource blocks (PRBs) in the second downlink BWP to total downlink PRBs in the second downlink BWP, or (ii) a second ratio of usable uplink PRBs in the second uplink BWP to total uplink PRBs in the second uplink BWP.

Example 41 is the method of Example 40, wherein: the SBFD resources are associated with an uplink subband and a downlink subband; the usable downlink PRBs are resources of the downlink subband that overlap with resources of the second downlink BWP; and the usable uplink PRBs are resources of the uplink subband that overlap with resources of the second downlink BWP.

Example 42 is the method of any of Examples 40 and 41, wherein and at least one of: the second uplink BWP occupies a greater portion of the channel bandwidth than the first uplink BWP; or the second downlink BWP occupies a greater portion of the channel bandwidth than the first downlink BWP.

Example 43 is the method of any of Examples 39-42, wherein the method further comprises: obtaining an SBFD configuration indicative of one or more of: (i) an uplink subband and a downlink subband of the SBFD resources, and (ii) the second BWP pair and its association with the SBFD resources.

Example 44 is the method of Example 43, wherein at least one of: the SBFD configuration is further indicative of time locations associated with the SBFD resources; or the time locations are within a time-division duplex (TDD) pattern period.

Example 45 is the method of any of Examples 43 and 44, wherein the indication of the second BWP pair comprises one of: (i) a configuration of resources associated with the second BWP pair or (ii) an identifier of the second BWP pair.

Example 46 is the method of any of Examples 39-45, wherein the method further comprises: obtaining an indication of a switch from the non-SBFD resources to the SBFD resources, and wherein the switch from the first BWP pair to the second BWP pair occurs after obtaining the indication of the switch.

Example 47 is the method of any of Examples 39-46, wherein the method further comprises: obtaining an indication of deactivation of the SBFD resources; and communicating with the second wireless node by switching from the second BWP pair to the first BWP pair, said communication being via non-SBFD resources and occurring after obtaining the indication of deactivation.

Example 48 is the method of any of Examples 39-47, wherein at least one of: an uplink BWP of the second BWP pair occupies the entire channel bandwidth; or a downlink BWP of the second BWP pair occupies the entire channel bandwidth.

Example 49 is the method of any of Examples 39-48, wherein the method further comprises: outputting, for transmission to the second wireless node, an indication of a capability of the first wireless node, the capability comprising at least one of: (i) a capability to switch from the first BWP pair to the second BWP pair for communication with the second wireless node via SBFD resources; or (ii) a capability to obtain a configuration of resources associated with the second BWP pair.

Example 50 is the method of any of Examples 39-49, wherein the method further comprises: obtaining a request for the first wireless node to switch from the second BWP pair to the first BWP pair or another non-SBFD BWP pair; switching from the second BWP pair to the first BWP pair or the other non-SBFD BWP pair after obtaining the request; and communicating with the second wireless node via the first BWP pair or the other non-SBFD BWP pair.

Example 51 is the method of any of Examples 39-50, wherein the method further comprises: switching from the second BWP pair to the first BWP pair or another non-SBFD BWP pair after communicating via the second BWP pair for a time duration.

Example 52 is the method of Example 51, wherein the time duration is equal to a duration of communication with the second wireless node via the SBFD resources.

Example 53 is the method of any of Examples 39-52, wherein at least one of: the communication with the second wireless node is via a time-division duplex (TDD) communication scheme; the non-SBFD resources are contained within a first slot; or the SBFD resources are contained within at least one of the first slot or a second slot.

Example 54 is the method of Example 53, wherein the method further comprises: obtaining an indication of a pattern associated with the TDD communication scheme; and obtaining an indication of the SBFD resources within a time period, wherein at least one of: the time period is equal to a duration of the pattern or is an integer multiple of the duration of the pattern, or the integer is greater than 1.

Example 55 is the method of Example 54, wherein the method further comprises: switching from the second BWP pair to the first BWP pair or another non-SBFD BWP pair after expiration of the time period.

Example 56 is a method for wireless communication at a first wireless node, comprising: communicating with a second wireless node, said communication being via non-subband full-duplex (non-SBFD) resources associated with a channel bandwidth and via a first bandwidth part (BWP) pair; and communicating with the second wireless node by switching from the first BWP pair to a second BWP pair, said communication being via SBFD resources associated with the channel bandwidth, wherein the second BWP pair occupies a greater portion of the channel bandwidth relative to the first BWP pair.

Example 57 is the method of Example 56, wherein at least one of: the first BWP pair comprises a first uplink BWP and a first downlink BWP; the second BWP pair comprises a second uplink BWP and a second downlink BWP; or the second BWP pair is configured to provide at least one of: (i) a first ratio of usable downlink physical resource blocks (PRBs) in the second downlink BWP to total downlink PRBs in the second downlink BWP, or (ii) a second ratio of usable uplink PRBs in the second uplink BWP to total uplink PRBs in the second uplink BWP.

Example 58 is the method of Example 57, wherein: the SBFD resources are associated with an uplink subband and a downlink subband; the usable downlink PRBs are resources of the downlink subband that overlap with resources of the second downlink BWP; and the usable uplink PRBs are resources of the uplink subband that overlap with resources of the second downlink BWP.

Example 59 is the method of any of Examples 57 and 58, wherein at least one of: the second uplink BWP occupies a greater portion of the channel bandwidth than the first uplink BWP; or the second downlink BWP occupies a greater portion of the channel bandwidth than the first downlink BWP.

Example 60 is the method of any of Examples 56-59, wherein the method further comprises: outputting, for transmission to the second wireless node, an SBFD configuration indicative of one or more: (i) an uplink subband and a downlink subband of the SBFD resources, and (ii) the second BWP pair and its association with the SBFD resources.

Example 61 is the method of Example 60, wherein at least one of: the SBFD configuration is further indicative of time locations associated with the SBFD resources; or the time locations are within a time-division duplex (TDD) pattern period.

Example 62 is the method of any of Examples 60 and 61, wherein the indication of the second BWP pair comprises one of: (i) a configuration of resources associated with the second BWP pair or (ii) an identifier of the second BWP pair.

Example 63 is the method of any of Examples 56-62, wherein the method further comprises: outputting, for transmission to the second wireless node, an indication of a switch from the non-SBFD resources to the SBFD resources, and wherein the switch from the first BWP pair to the second BWP pair occurs after outputting the indication of the switch.

Example 64 is the method of any of Examples 56-63, wherein the method further comprises: outputting, for transmission to the second wireless node, an indication of deactivation of the SBFD resources; and communicating, with the second wireless node, by switching from the second BWP pair to the first BWP pair, said communication being via non-SBFD resources after outputting the indication of deactivation.

Example 65 is the method of any of Examples 56-64, wherein the method further comprises: obtaining an indication of a capability of the second wireless node, the capability comprising at least one of: (i) a capability to switch from the first BWP pair to the second BWP pair for communication with the first wireless node via SBFD resources; or a capability to obtain a configuration of resources associated with the second BWP pair.

Example 66 is the method of any of Examples 56-65, wherein the method further comprises: outputting, for transmission to the second wireless node, a request for the second wireless node to switch from the second BWP pair to the first BWP pair or another non-SBFD BWP pair; switching from the second BWP pair to the first BWP pair or the other non-SBFD BWP pair after outputting the request; and communicating with the second wireless node via the first BWP pair or the other non-SBFD BWP pair.

Example 67 is the method of any of Examples 56-66, wherein the method further comprises: switching from the second BWP pair to the first BWP pair or another non-SBFD BWP pair after communicating via the second BWP pair for a time duration.

Example 68 is the method of Example 67, wherein the time duration is equal to a duration of communication with the second wireless node via the SBFD resources.

Example 69 is the method of any of Examples 56-68, wherein at least one of: the communication with the second wireless node is via a time-division duplex (TDD) communication scheme; the non-SBFD resources are contained within a first slot; or the SBFD resources are contained within at least one of the first slot or a second slot.

Example 70 is the method of Example 69, wherein the method further comprises: outputting, for transmission to the second wireless node, an indication of a pattern associated with the communication TDD scheme; and outputting, for transmission to the second wireless node, an indication of the SBFD resources within a time period, wherein at least one of: the time period is: (i) equal to a duration of the pattern or (ii) an integer multiple of the duration of the pattern; or the integer is greater than 1.

Example 71 is the method of any of Examples 69 and 70, wherein the method further comprises: switching from the second BWP pair to the first BWP pair or another non-SBFD BWP pair after expiration of the time period.

Example 72 is the method of any of Examples 56-71, further comprising: communicating, with the second wireless node, an SBFD configuration indicative of one or more of: (i) an uplink subband and a downlink subband of the SBFD resources, and (ii) the second BWP pair and its association with the SBFD resources.

Example 73 is the method of any of Exampled 56-72, further comprising: communicating, with the second wireless node, an indication of a switch from the non-SBFD resources to the SBFD resources, and wherein the switch from the first BWP pair to the second BWP pair occurs after the communication of the indication of the switch.

Example 74 is the method of any of Examples 56-73, further comprising: obtaining an indication of deactivation of the SBFD resources; and communicating, with the second wireless node, by switching from the second BWP pair to the first BWP pair, said communication being via non-SBFD resources and occurring after obtaining the indication of deactivation.

Example 75 is the method of any of Examples 56-74, further comprising: outputting, for transmission to the second wireless node, an indication of a capability of the first wireless node, the capability comprising at least one of: (i) a capability to switch from the first BWP pair to the second BWP pair for communication with the second wireless node via SBFD resources, or (ii) a capability to obtain a configuration of resources associated with the second BWP pair.

Example 76 is the method of any of Examples 56-75, further comprising: obtaining a request for the first wireless node to switch from the second BWP pair to the first BWP pair or another non-SBFD BWP pair; switching from the second BWP pair to the first BWP pair or the other non-SBFD BWP pair after obtaining the request; and communicating with the second wireless node via the first BWP pair or the other non-SBFD BWP pair.

Example 77 if the method of any of Examples 56-76, further comprising: outputting, for transmission to the second wireless node, a request for the second wireless node to switch from the second BWP pair to the first BWP pair or another non-SBFD BWP pair; switching from the second BWP pair to the first BWP pair or the other non-SBFD BWP pair after outputting the request; and communicating with the second wireless node via the first BWP pair or the other non-SBFD BWP pair.

Example 78 is the method of Example 69, further comprising: communicating, with the second wireless node, at least one of: an indication of a pattern associated with the TDD communication scheme or an indication of the SBFD resources within a time period, wherein at least one of: the time period is equal to a duration of the pattern or is an integer multiple of the duration of the pattern, or the integer is greater than 1.

Example 79 is the method of any of Examples 56-78, wherein at least one of: an uplink BWP of the second BWP pair occupies the entire channel bandwidth; or a downlink BWP of the second BWP pair occupies the entire channel bandwidth.

Example 80 is an apparatus for wireless communications, comprising means for performing a method in accordance with any one of examples 39-55.

Example 81 is an apparatus for wireless communications, comprising means for performing a method in accordance with any one of examples 56-78.

Example 82 is a non-transitory computer-readable medium comprising instructions that, when executed by a wireless node, cause the wireless node to perform a method in accordance with any one of examples 39-55.

Example 83 is a non-transitory computer-readable medium comprising instructions that, when executed by a wireless node, cause the wireless node to perform a method in accordance with any one of examples 56-78.

Example 84 is an apparatus for wireless communications, comprising: one or more memories, individually or in combination, having instructions; and one or more processors, individually or in combination, configured to execute the instructions and cause the apparatus to perform a method in accordance with any one of examples 39-55.

Example 85 is an apparatus for wireless communications, comprising: one or more memories, individually or in combination, having instructions; and one or more processors, individually or in combination, configured to execute the instructions and cause the apparatus to perform a method in accordance with any one of examples 56-78.

Example 86 is a wireless node (e.g., UE), comprising: one or more transceivers via which communication with the wireless node occurs; one or more memories, individually or in combination, having instructions; and one or more processors, individually or in combination, configured to execute the instructions and cause the wireless node to perform a method in accordance with any one of examples 39-55, wherein the one or more transceivers are configured to: communicate with the second wireless node via non-SBFD resources; and communicate with the second wireless node by switching from the first BWP pair to the second BWP pair.

Example 87 is a wireless node (e.g., network entity), comprising: one or more transceivers via which communication with the wireless node occurs; one or more memories, individually or in combination, having instructions; and one or more processors, individually or in combination, configured to execute the instructions and cause the wireless node to perform a method in accordance with any one of examples 56-78, wherein the one or more transceivers are configured to: communicate with the second wireless node via non-SBFD resources; and communicate with the second wireless node by switching from the first BWP pair to the second BWP pair.

What is claimed is:

1. An apparatus for wireless communication, comprising:
one or more memories, individually or in combination, having instructions; and
one or more processors, individually or in combination, configured to execute the instructions and cause the apparatus to:
communicate with a wireless node, said communication being via non-subband full-duplex (non-SBFD) resources associated with a channel bandwidth and via a first bandwidth part (BWP) pair; and
communicate with the wireless node by switching from the first BWP pair to a second BWP pair, said communication being via SBFD resources associated with the channel bandwidth, wherein the second BWP pair occupies a greater portion of the channel bandwidth relative to the first BWP pair.

2. The apparatus of claim 1, wherein at least one of:
the first BWP pair comprises a first uplink BWP and a first downlink BWP;
the second BWP pair comprises a second uplink BWP and a second downlink BWP; or
the second BWP pair is configured to provide at least one of: (i) a first ratio of usable downlink physical resource blocks (PRBs) in the second downlink BWP to total downlink PRBs in the second downlink BWP, or (ii) a second ratio of usable uplink PRBs in the second uplink BWP to total uplink PRBs in the second uplink BWP.

3. The apparatus of claim 2, wherein:
the SBFD resources are associated with an uplink subband and a downlink subband;
the usable downlink PRBs are resources of the downlink subband that overlap with resources of the second downlink BWP; and
the usable uplink PRBs are resources of the uplink subband that overlap with resources of the second downlink BWP.

4. The apparatus of claim 2, wherein and at least one of:
the second uplink BWP occupies a greater portion of the channel bandwidth than the first uplink BWP; or
the second downlink BWP occupies a greater portion of the channel bandwidth than the first downlink BWP.

5. The apparatus of claim 1, wherein the one or more processors, individually or in combination, are further configured to cause the apparatus to:
communicate, with the wireless node, an SBFD configuration indicative of one or more of: (i) an uplink subband and a downlink subband of the SBFD resources, and (ii) the second BWP pair and its association with the SBFD resources.

6. The apparatus of claim 5, wherein at least one of:
the SBFD configuration is further indicative of time locations associated with the SBFD resources; or
the time locations are within a time-division duplex (TDD) pattern period.

7. The apparatus of claim 5, wherein the indication of the second BWP pair comprises one of: (i) a configuration of resources associated with the second BWP pair or (ii) an identifier of the second BWP pair.

8. The apparatus of claim 1, wherein the one or more processors, individually or in combination, are further configured to cause the apparatus to:
communicate, with the wireless node, an indication of a switch from the non-SBFD resources to the SBFD resources, and wherein the switch from the first BWP pair to the second BWP pair occurs after the communication of the indication of the switch.

9. The apparatus of claim 1, wherein the one or more processors, individually or in combination, are further configured to cause the apparatus to:
obtain an indication of deactivation of the SBFD resources; and
communicate, with the wireless node, by switching from the second BWP pair to the first BWP pair, said communication being via non-SBFD resources and occurring after obtaining the indication of deactivation.

10. The apparatus of claim 1, wherein the one or more processors, individually or in combination, are further configured to cause the apparatus to:
output, for transmission to the wireless node, an indication of deactivation of the SBFD resources; and
communicate, with the wireless node, by switching from the second BWP pair to the first BWP pair, said communication being via non-SBFD resources after outputting the indication of deactivation.

11. The apparatus of claim 1, wherein at least one of:
an uplink BWP of the second BWP pair occupies the entire channel bandwidth; or
a downlink BWP of the second BWP pair occupies the entire channel bandwidth.

12. The apparatus of claim 1, wherein the one or more processors, individually or in combination, are further configured to cause the apparatus to:
output, for transmission to the wireless node, an indication of a capability of the apparatus, the capability comprising at least one of: (i) a capability to switch from the first BWP pair to the second BWP pair for communication with the wireless node via SBFD resources, or (ii) a capability to obtain a configuration of resources associated with the second BWP pair.

13. The apparatus of claim 1, wherein the one or more processors, individually or in combination, are further configured to cause the apparatus to:
obtain an indication of a capability of the wireless node, the capability comprising at least one of: (i) a capability to switch from the first BWP pair to the second BWP pair for communication with the apparatus via SBFD resources, or (ii) a capability to obtain a configuration of resources associated with the second BWP pair.

14. The apparatus of claim 1, wherein the one or more processors, individually or in combination, are further configured to cause the apparatus to:
obtain a request for the apparatus to switch from the second BWP pair to the first BWP pair or another non-SBFD BWP pair;
switch from the second BWP pair to the first BWP pair or the other non-SBFD BWP pair after obtaining the request; and
communicate with the wireless node via the first BWP pair or the other non-SBFD BWP pair.

15. The apparatus of claim 1, wherein the one or more processors, individually or in combination, are further configured to cause the apparatus to:
output, for transmission to the wireless node, a request for the wireless node to switch from the second BWP pair to the first BWP pair or another non-SBFD BWP pair;
switch from the second BWP pair to the first BWP pair or the other non-SBFD BWP pair after outputting the request; and
communicate with the wireless node via the first BWP pair or the other non-SBFD BWP pair.

16. The apparatus of claim 1, wherein the one or more processors, individually or in combination, are further configured to cause the apparatus to:
switch from the second BWP pair to the first BWP pair or another non-SBFD BWP pair after communicating via the second BWP pair for a time duration.

17. The apparatus of claim 16, wherein the time duration is equal to a duration of communication with the wireless node via the SBFD resources.

18. The apparatus of claim 1, wherein at least one of:
the communication with the wireless node is via a time-division duplex (TDD) communication scheme;
the non-SBFD resources are contained within a first slot; or
the SBFD resources are contained within at least one of the first slot or a second slot.

19. The apparatus of claim 18, wherein the one or more processors, individually or in combination, are further configured to cause the apparatus to:
communicate, with the wireless node, at least one of: an indication of a pattern associated with the TDD communication scheme or an indication of the SBFD resources within a time period, wherein at least one of:
the time period is equal to a duration of the pattern or is an integer multiple of the duration of the pattern, or
the integer is greater than 1.

20. The apparatus of claim 19, wherein the one or more processors, individually or in combination, are further configured to cause the apparatus to:
switch from the second BWP pair to the first BWP pair or another non-SBFD BWP pair after expiration of the time period.
